(19) United States
(12) Patent Application Publication
(10) Pub. No.: US 2021/0097528 A1
(43) Pub. Date: Apr. 1, 2021

(54) BLOCKCHAIN HOT WALLET BASED ON SECURE ENCLAVE AND MULTI-SIGNATURE AUTHORIZATION

(71) Applicant: Rui Wang, Foster City, CA (US)

(72) Inventor: Rui Wang, Foster City, CA (US)

(21) Appl. No.: 17/017,424

(22) Filed: Sep. 10, 2020

Related U.S. Application Data
(60) Provisional application No. 62/906,505, filed on Sep. 26, 2019.
(60) Provisional application No. 62/912,548, filed on Oct. 8, 2019.
(60) Provisional application No. 62/912,549, filed on Oct. 8, 2019.
(60) Provisional application No. 62/912,553, filed on Oct. 8, 2019.
(60) Provisional application No. 62/912,554, filed on Oct. 8, 2019.
(60) Provisional application No. 62/925,678, filed on Oct. 24, 2019.
(60) Provisional application No. 62/925,680, filed on Oct. 24, 2019.
(60) Provisional application No. 62/925,681, filed on Oct. 24, 2019.
(60) Provisional application No. 62/925,684, filed on Oct. 24, 2019.
(60) Provisional application No. 62/929,665, filed on Nov. 1, 2019.
(60) Provisional application No. 62/929,667, filed on Nov. 1, 2019.
(60) Provisional application No. 62/929,672, filed on Nov. 1, 2019.

(51) Int. Cl. G06Q 20/36; H04L 9/06; H04L 9/32; H04L 9/30

(52) U.S. Cl. CPC G06Q 20/3674; H04L 9/0643; H04L 2209/56; H04L 9/30; H04L 2209/38; H04L 9/3247

(57) ABSTRACT

Techniques to implement system and methods in which a blockchain hot wallet based on secure enclave and multi-signature authorization. A computer system may obtain, within a protected execution environment, at least a plurality of approver digital signatures, a message, and a raw blockchain transaction, verify validity of at least a subset of the plurality of approver digital signatures, verify that the message and the raw blockchain transaction match, on a condition that at least the subset of approver digital signatures are valid and that the message matches the raw blockchain transaction, use a private key to generate a digital signature over the raw blockchain transaction, and make at least the digital signature generated over the raw blockchain transaction available outside of the protected execution environment. Techniques described herein may utilize secure enclaves to implement protected execution environments.

### CROSS-REFERENCE TO RELATED APPLICATIONS

This application claims priority to U.S. Patent Application No. 62/906,505, filed on Sep. 26, 2019, entitled “VALIDATING BLOCKCHAIN TRANSACTIONS”; U.S. Patent Application No. 62/912,548, filed on Oct. 8, 2019, entitled “BLOCKCHAIN HOT WALLET BASED ON SECURE ENCLAVE AND MULTI-SIGNATURE AUTHORIZATION”; U.S. Patent Application No. 62/912,549, filed on Oct. 8, 2019, entitled “SECURE ADMIN COMMANDS WITH SECURE ENCLAVE AND MULTI-SIGNATURE AUTHORIZATION”; U.S. Patent Application No. 62/912,553, filed on Oct. 8, 2019, entitled “BLOCKCHAIN HOT WALLET BASED ON SECURE ENCLAVE AND POLICY ENFORCEMENT”; U.S. Patent Application No. 62/912,554, filed on Oct. 8, 2019, entitled “BLOCKCHAIN HOT WALLET BASED ON NETWORK ISOLATION”; U.S. Patent Application No. 62/925,678, filed on Oct. 24, 2019, entitled “SECURE DEPOSIT HOT WALLET OF CRYPTOCURRENCY EXCHANGE WITH SECURE ENCLAVE”; U.S. Patent Application No. 62/925,680, filed on Oct. 24, 2019, entitled “SECURE WITHDRAW HOT WALLET OF CRYPTOCURRENCY EXCHANGE WITH SECURE ENCLAVE”; U.S. Patent Application No. 62/925,681, filed on Oct. 24, 2019, entitled “SECURE STAKING HOT WALLET WITH SECURE ENCLAVE”; U.S. Patent Application No. 62/925,684, filed on Oct. 24, 2019, entitled “SECURE OFF-CHAIN EXCHANGE WITH SECURE ENCLAVE”; U.S. Patent Application No. 62/929,665, filed on Nov. 1, 2019, entitled “SECURE HOT WALLET BASED ON SECURE ENCLAVE AND PROGRAMMABLE POLICY ENFORCEMENT”; U.S. Patent Application No. 62/929,667, filed on Nov. 1, 2019, entitled “SECURE SMART CONTRACT WITH SECURE ENCLAVE AND MULTI-SIGNATURE AUTHORIZATION”; and U.S. Patent Application No. 62/929,672, filed on Nov. 1, 2019, entitled “SECURE STORAGE OF WALLET DATA AND POLICIES BASED ON SECURE ENCLAVES,” the disclosures of which are hereby incorporated herein in their entirety.

### BACKGROUND

Blockchain hot wallets may have various characteristics, such as being easy to use and providing quick access to digital assets. However, blockchain hot wallets, by virtue of being connected in an online environment, may be exposed to security risks. For example, malicious entities may use computer-based attacks and malware to attempt to steal wallet private keys and use them to steal digital assets of a hot wallet.

### BRIEF DESCRIPTION OF THE DRAWINGS

Various techniques will be described with reference to the drawings, in which:

FIG. 1 illustrates a diagram to implement blockchain hot wallet with secure enclave and multi-signature authorization, in accordance with at least one embodiment;

FIG. 2 illustrates a diagram to implement secure admin commands with secure enclave and multi-signature authorization, in accordance with at least one embodiment;

FIG. 3 illustrates a diagram to implement blockchain hot wallet based on secure enclave and policy enforcement, in accordance with at least one embodiment;

FIG. 4 illustrates a diagram to implement blockchain hot wallet based on network isolation, in accordance with at least one embodiment;

FIG. 5 is a schematic diagram illustrating one or more processes in accordance with embodiments herein;

FIG. 6 is another schematic diagram illustrating one or more processes in accordance with embodiments herein;

FIG. 7 is a diagram of an illustrative scheme of a computing architecture implementing operations described in FIGS. 5 and/or 6;

FIG. 8 illustrates a diagram to implement secure deposit hot wallet of cryptocurrency exchange with secure enclave, in accordance with at least one embodiment;

FIG. 9 illustrates a diagram to implement secure withdraw hot wallet of cryptocurrency exchange with secure enclave, in accordance with at least one embodiment;

FIG. 10 illustrates a diagram to implement secure staking hot wallet with secure enclave, in accordance with at least one embodiment;

FIG. 11 illustrates a diagram to implement secure off-chain exchange with secure enclave, in accordance with at least one embodiment;

FIG. 12 illustrates a diagram to implement secure hot wallet system based on secure enclave and programmable policy enforcement, in accordance with at least one embodiment;

FIG. 13 illustrates a diagram to implement loading trusted data from blockchain to secure enclave with multi-signature authorization, in accordance with at least one embodiment;

FIG. 14 illustrates a diagram to implement secure smart contract with secure enclave and multi-signature authorization, in accordance with at least one embodiment;

FIG. 15 illustrates a diagram to implement secure storage of wallet data and policies based on secure enclaves, in accordance with at least one embodiment;

FIG. 16 illustrates a diagram to implement secure storage of wallet data and policies based on secure enclaves, in accordance with at least one embodiment;

FIG. 17 illustrates a diagram to implement secure storage of wallet data and policies based on secure enclaves, in accordance with at least one embodiment;

FIG. 18 illustrates a diagram to implement secure blockchain transaction fee charging with secure enclave, in accordance with at least one embodiment;

FIG. 19 illustrates an example of a computing environment including an enclave to implement a protected execution environment, in accordance with an embodiment; and

FIG. 20 illustrates an environment in which various embodiments can be implemented.

### DETAILED DESCRIPTION

This document describes techniques for various blockchain-related inventions that utilize secure enclaves. In one embodiment, a hot wallet with secure enclave is implemented to support multi-signature authorization in which a quorum of two or more signers are required to authorize the generation of a digital signature over a blockchain transaction which allows the blockchain transaction to be properly validated, processed, and confirmed on a blockchain network. In one embodiment, a command such as an administrative command is implemented to support multi-signature authorization in which a quorum of two or more admins are required to authorize the execution of the command. In one embodiment, a hot wallet with secure enclave is implemented to support global and user-specific policies that enforce a set of conditions on how the hot wallet can be used. In one embodiment, a hot wallet with secure enclave is implemented with network isolation such that a malicious user is physically and/or isolated from the hot wallet, making it difficult or impossible to perform computer-based attacks on the hot wallet.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

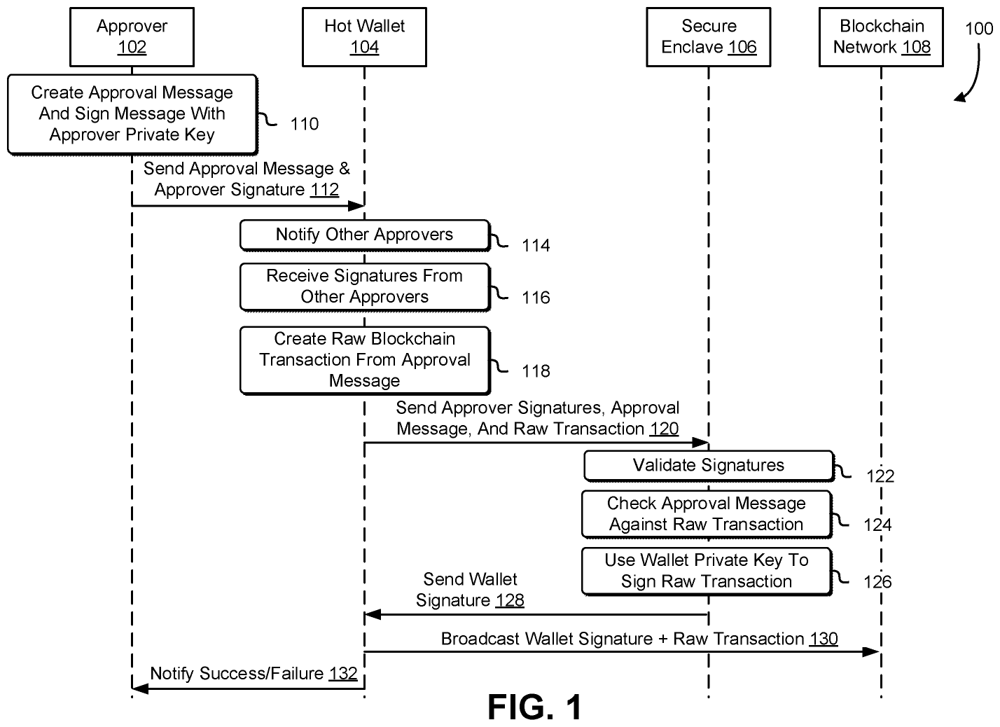

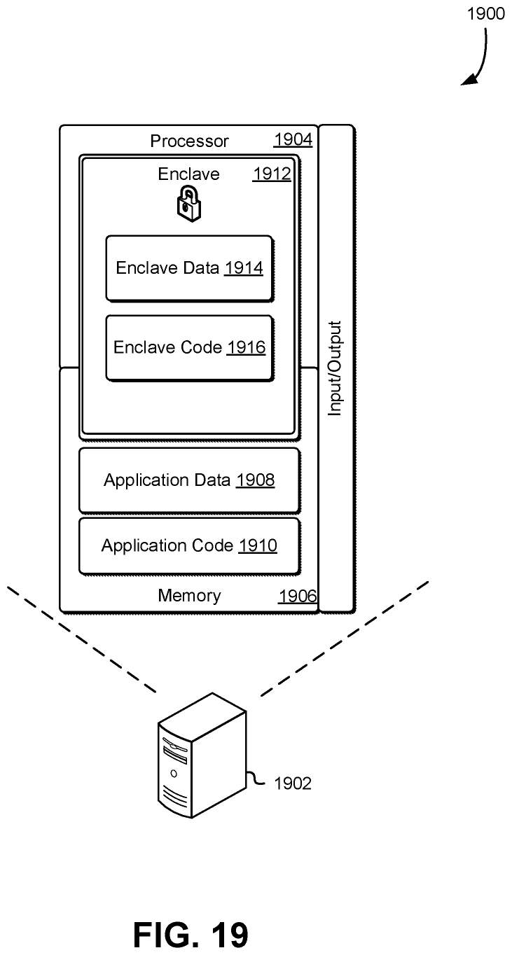

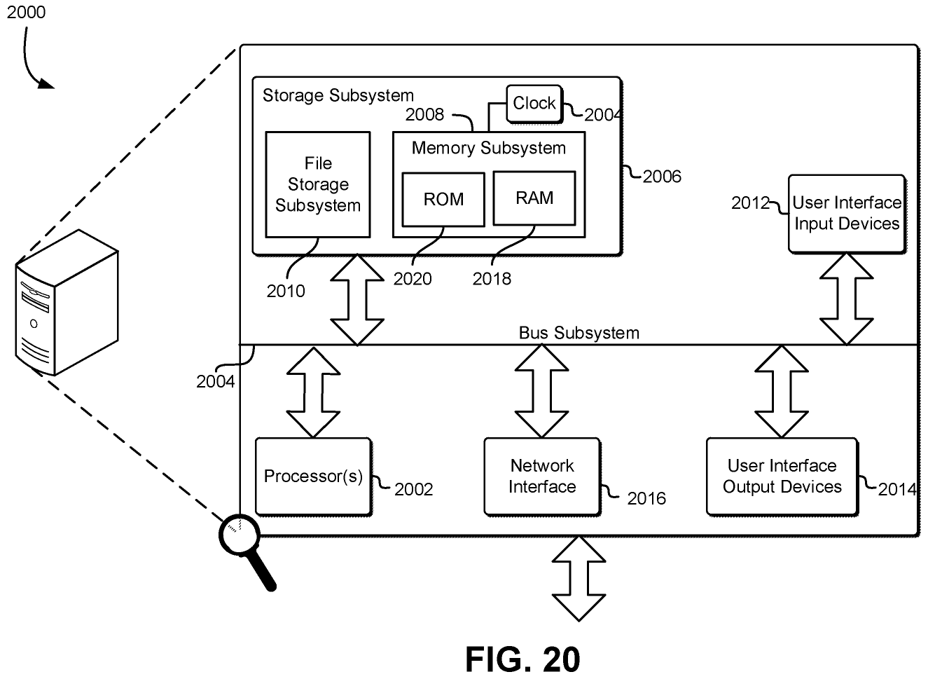

FIG. 1 illustrates a diagram 100 in which various embodiments may be practiced. FIG. 1 illustrates an approver 102, a hot wallet 104, a secure enclave 106, and a blockchain network 108. FIG. 1 may be implemented by one or more computer systems such as those described in connection with FIGS. 19 and 20.

Approver 102 may be implemented using a computer system such as those described in connection with FIG. 20. The approver 102 may be implemented using hardware, software, or a combination thereof. The approver 102 may include a user interface that is accessible to an end-user entity (e.g., human being) which may be involved in the execution of various steps illustrated in FIG. 1.

Hot wallet 104 may refer to a blockchain wallet that is online or otherwise connected to a blockchain network in one manner or another. A hot wallet may be contrasted to a cold wallet which is offline and whose private key is generally inaccessible for signing. A hot wallet may be used for digitally signing raw blockchain transactions which can be processed on a blockchain network. A hot wallet may have an associated asymmetric key pair in which a private key (kept secret by the user controlling the hot wallet 104) is used to generate digital signatures and a corresponding public key which is used by other users of the blockchain network to validate that the user controlling the hot wallet authorized a specific blockchain transaction. A raw blockchain transaction may refer to the data of a blockchain transaction that encodes what the blockchain transaction is to do, whereas the digital signature is an attestation of authorization by the user controlling the hot wallet to process the blockchain transaction. Techniques described elsewhere in this embodiment may be utilized to implement these attestations.

Secure enclave 106 may be implemented in accordance with enclaves described elsewhere in this disclosure, such as those discussed in connection with FIG. 19. For example, secure enclave may include enclave code and/or enclave data that is executed in the context of a protected execution environment. Secure enclave 106 may securely store a wallet private key. In at least some embodiments, the wallet private key is a private key of an asymmetric key pair which is associated with a blockchain address for the hot wallet 104. The private key may be used to digitally sign blockchain transactions that provide cryptographically verifiable assurance of non-repudiation, integrity, and/or authenticity. Integrity may refer to assurances that a received message was not modified either intentionally (e.g., by a malicious party) or unintentionally (e.g., as a result of signal loss during transmission) from its original form when the message was transmitted. Nonrepudiation may refer to assurances that a party that digitally signs a blockchain transaction cannot deny the authenticity of the transaction.

Blockchain network 108 may be implemented as any suitable blockchain network, such as those described elsewhere in this disclosure. As an example, the blockchain network 108 may be a public chain such as a blockchain network based on Bitcoin, Ethereum, or EOS. The blockchain network may include nodes which are used to validate blockchain transactions. For example, a blockchain transaction may be digitally signed by a sender and broadcasted to the blockchain network 108. Nodes of the blockchain network may receive the broadcasted blockchain transaction and validate the blockchain transaction. Validation of the blockchain transaction may include verification of the digital signature. For example, the wallet public key of the hot wallet may be used to cryptographically verify that the blockchain transaction described in FIG. 1 was authorized. The wallet public key, corresponding to the wallet private key, may be accessible to users of the blockchain network. Additional validation checks may be made—for example, that a digital token being transferred is under the control of the hot wallet, that the hot wallet has sufficient fungible tokens (e.g., gas) to transfer, as indicated by an amount encoded in the blockchain transaction.

As illustrated in FIG. 1, approver 102 may create 110 an approval message and sign the message with an approver private key. Any suitable digital signature scheme may be used to sign the message. The message may indicate one or more parameters of a blockchain transaction which should be broadcasted to the blockchain network 108. In some cases, the raw blockchain transaction (without digital signature) is provided by the approver to hot wallet 104. Approver 102 may send 112 the approver's digital signature and approval message to hot wallet 104 in any suitable manner, such as in the form of an application programming interface (API) request.

In some embodiments, approver 102 establishes a cryptographically protected communications session with hot wallet 104. For example, approver 102 may establish a Transport Layer Security (TLS) session and send the approval message to the hot wallet 104 using an encrypted session. In some embodiments, such as those that utilize a TLS session to provide a confidential communications session between approver 102 and hot wallet 104, sending the approval signature with the message is optional as the approver 102 and hot wallet 104 may perform mutual authentication of each other's identifies as part of a handshake process establishing the cryptographically protected communications session.

Hot wallet 104 may receive the approver's digital signature and/or approval message. The hot wallet 104 may verify the authenticity of the approver's signature using a public key associated with approver 102. If the digital signature is not valid, the message may be discarded and processing of the approver's request halted. In some embodiments, hot wallet 104 notifies 114 other approvers (e.g., administrators or users) and requests indications of approval from the other approvers. For example, hot wallet 104 may request that other approvers send digital signatures indicating that they authorize (e.g., approve) generating a blockchain transaction based on the message sent by approver 102. In some embodiments, the list of approvers is managed by an administrator or by a quorum of administrators.

Hot wallet 104 may receive 116 indications from the other approvers that they individually authorize generation of a blockchain transaction based on the message. The indications may be in the form of digital signatures digitally signed by the other approvers. It should be noted that any individual digital signature may, on its own, be insufficient to cause secure enclave 106 to generate and digitally sign a blockchain transaction. Rather, digital signatures from a threshold number or proportion of approvers may be needed to cause the secure enclave 106 to use the wallet private key to sign the blockchain transaction. As an example, approver 102 may generate a digital signature over the approval message and provide both to hot wallet 104. The approval message and/or digital signature may then be provided to other approvers to review. The other approvers may indicate agreement by generating corresponding digital signatures using their respective private keys, which may be generated over the approval message and/or the digital signature of the initial approver 102.

In some embodiments, a quorum of approver digital signatures are received by hot wallet 104 and, in response, hot wallet 104 creates 118 creates a raw blockchain transaction based on the approval message. The raw blockchain transaction may refer to a blockchain transaction which encodes one or more parameters from the approval message, such as a blockchain address of a digital asset under the control of hot wallet 104, a recipient blockchain address to transfer control of the digital asset to, a nonce, and various other fields. The raw blockchain transaction by itself may be insufficient to be validated and accepted by blockchain network 108, at least because the raw blockchain transaction lacks a digital signature generated by the wallet private key, which may be inaccessible to the hot wallet 104 outside of secure enclave 106.

Hot wallet 104 may send 120 some or all approver signatures, the approval message, and the raw blockchain transaction. The hot wallet 104 may invoke an enclave entry point to initiate processing of raw blockchain transaction in a protected execution environment. In some embodiments, hot wallet 104 does not directly send some or all of the approver signatures, the approval message, and/or the raw blockchain transaction, but instead retains some or all of that information in memory external to the secure enclave 106 which is accessible to the secure enclave 106.

Invocation of an enclave entry point may transaction execution of a computer program from a non-protected execution environment to a protected execution environment. In some embodiments, the enclave entry point accepts one or more parameters which can be either optional or required parameters. For example, an enclave entry point may pass a list of approver digital signatures, an approval message, and a raw blockchain transaction to a protected execution environment such as secure enclave 106. An approval message may include a blockchain identifier, token address, wallet address, recipient address, and digital assets. Digital assets indicated in an approval message may be encoded as a token address or as an amount of non-fungible tokens. Other information to generate raw blockchain transactions may be included as well, but are omitted from FIG. 1 for clarity. For example, a nonce that is a number used only once may be included to prevent replay attacks.

Secure enclave 106 may check 122 validity of approver signatures using any suitable signature verification routine. For example, the secure enclave 106 may generate a first value using the approval message as an input to a one-way function to generate a first output and generate a second output by decrypting an approver digital signature with the approver's corresponding public key. If the first value and the second value match, the digital signature is considered valid. These steps may be repeated for each approver signature and corresponding approver public key. Once all approver signatures (or a sufficient quorum thereof) are validated, the secure enclave 106 may check 124 approval message against raw blockchain transaction.

Checking approval message against raw blockchain transaction may involve verifying that the parameters of the approval message are encoded in the raw blockchain transaction. For example, if the approval message includes a recipient blockchain address, an amount of digital assets to transfer, and so on, those values should be encoded in the raw blockchain transaction for the raw blockchain transaction to be valid. In some embodiments, the secure enclave 106 generates the raw blockchain transaction from the approval message rather than receiving it from the hot wallet 104 via an enclave entry point.

Once a raw blockchain transaction is obtained (e.g., generated or received via enclave entry point)—and in at least some cases, validated—the secure enclave may use 126 the wallet private key to digitally sign the raw blockchain transaction. In at least some embodiments, the digital signature generated over the raw blockchain transaction is an attestation that the hot wallet 104 authorizes the raw blockchain transaction and is used by nodes of the blockchain network 108 to validate that the raw blockchain transaction should be processed. The secure enclave 106 may send 128 the wallet signature and the raw blockchain transaction to the hot wallet 104. In some cases, the secure enclave provides only the wallet signature to the hot wallet 104, such as in embodiments where the hot wallet retains a copy of the raw blockchain transaction which can be associated with the wallet signature it receives from the secure enclave 106.

In at least some embodiments, the hot wallet 104 broadcasts 130 the wallet signature and raw blockchain transaction to blockchain network 108. Noes of the blockchain network 108 may use a public key associated with the hot wallet's blockchain address validate the wallet signature and raw blockchain transaction are valid, and process the raw blockchain transaction accordingly. For example, a balance of digital assets may be transferred from the hot wallet to another blockchain user as a result of processing the raw blockchain transaction. The hot wallet 104 may notify 132 the approver 102 of success or failure of the blockchain transaction based on whether the raw blockchain transaction was successfully broadcasted, processed, and/or confirmed to blockchain network 108.

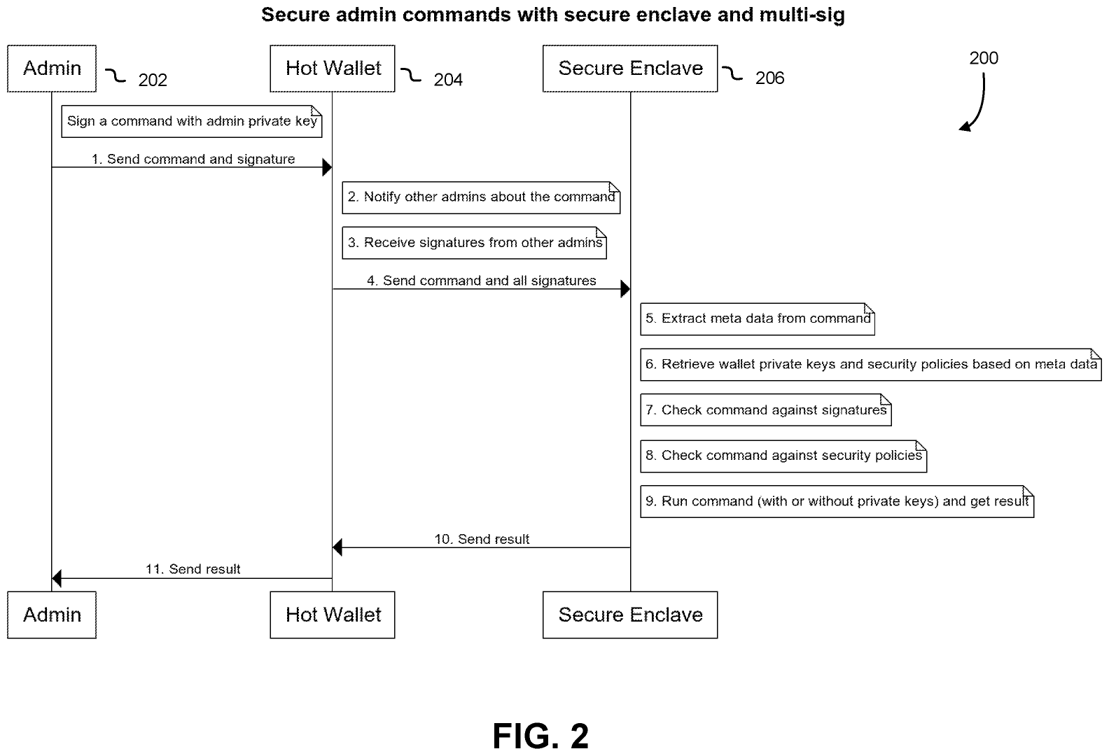

FIG. 2 illustrates a diagram 200 in which various embodiments may be practiced. FIG. 2 illustrates an admin 202, a hot wallet 204, and a secure enclave 206. FIG. 2 may be implemented by one or more computer systems such as those described in connection with FIGS. 19 and 20.

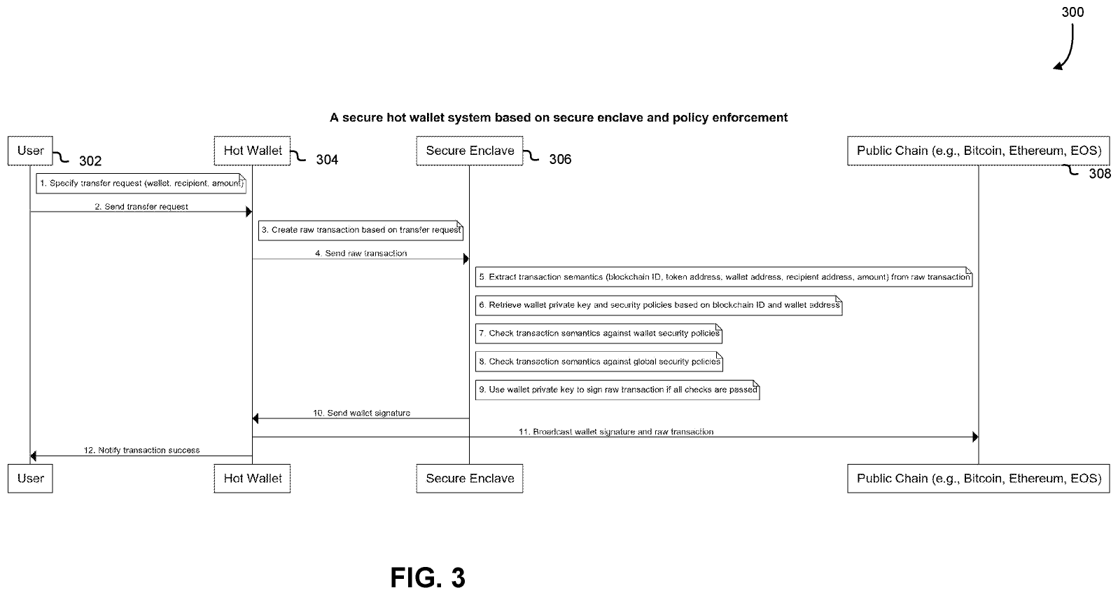

Admin 202 illustrated in FIG. 2 may be a user of a computer system such as hot wallet 204. Admin 202 may be a user with a set of permissions to issue commands to perform various operations. Various commands may be issues, such as those to manage or control the use of hot wallet 204. Admin 202 may, for example, be an employee of an organization that is tasked with management of hot wallet 204. In at least one embodiment, some commands can be unilaterally submitted by admin 202 without requiring other admins to sign. Diagram 200 may be implemented in the context of embodiments described in connection with other figures, such as FIGS. 1 and 3. The hot wallet 204 and secure enclave 206 may be implemented in accordance with those described elsewhere, such as embodiments discussed in connection with FIGS. 1, 19, and 20.

In various embodiments, one or more commands require additional authorization to be executed. Admin 202 may sign a command with a private key associated with the admin. For example, the command may be a command to manage hot wallet 204, such as managing global and/or user-specific policies. The command may be submitted to hot wallet 204.

Hot wallet 204 may receive request to execute the command from admin 202 along with an attestation indicating the admin authorizes the command. The attestation may, for example, be a digital signature generated over the command and/or parameters encoding how to execute the command. Hot wallet 204 may verify the digital signature and then notify other admins about the command, such as through a messaging, notification, or queuing system. The other admins may be notified as to which command is being requested, which admin initiated the request, parameters that specify how the command is to be executed, and any suitable combination thereof. Each admin may determine whether to emit an attestation indicating that they approve of the admin's requested command. Note that this approval itself does not allow execution of the command to occur, but rather, is used to provide an indication to secure enclave 206 that the particular admin approves of the request. In at least some embodiments, hot wallet 204 receives a quorum of approvals from other admins in the form of digital signatures. Hot wallet 204 may, upon receiving a sufficient number or percentage of digital signatures, send the command to execute and digital signatures to secure enclave 206. The sending may be via a pre-defined enclave entry point.

Examples of commands which an admin can submit may include one or more of the following: signing a blockchain transaction with a private key resident to a protected execution environment; creating a new wallet private key and associating it with predefined security policies; removing a new wallet private key and associated security policies; updating security policies associated with a wallet private key; adding and removing admins.

Secure enclave 206 may receive the command and digital signatures from multiple admins. In some cases, secure enclave verifies that the initial requestor's (e.g., admin 202) digital signature is valid. Secure enclave 206 may extract metadata from the command and/or parameters that indicate how to execute the command and retrieve wallet private keys and security policies based on the metadata. The secure enclave 206 may validate the digital signatures from the admins and verify authenticity, integrity, and authorization to execute the command. The requested command may be checked against security policies that may prohibit and/or explicitly allow (e.g., in a deny-by-default security regime). If the requested command is authorized to be executed, then the secure enclave may execute the command from within the context of a protected execution environment. In some cases, execution of the command uses a private key of hot wallet 204 which is resident to the secure enclave 206 and not exposed in a plaintext format outside of the protected execution environment of the enclave. The execution of the command may generate a result (e.g., success or failure), an error code, data, and the like. The result may be provided to the hot wallet 204, which may provide the result to the admin 202 that initiated the request.

FIG. 3 illustrates a diagram 300 in which various embodiments may be practiced. FIG. 3 illustrates a diagram of a secure hot wallet system based on secure enclave and policy enforcement. FIG. 3 illustrates a user 302, hot wallet 304, secure enclave 306, and blockchain network 308. FIG. 3 may be implemented by one or more computer systems such as those described in connection with FIGS. 19 and 20.

User 302 may be a user of hot wallet 304. User 302 may be a computing entity configured to submit requests to the hot wallet 304 to execute commands via an application programming interface (API). User 302 may specify a request to execute a blockchain transaction. A non-limiting example of a request is a transfer request that sends an amount of digital assets (e.g., ETH, BTC) from hot wallet 304 to another user (not shown in FIG. 3). The transfer request may be in the form of an API request that specifies wallet, recipient, and amount to transfer. User 302 may send the request to hot wallet 304 in any suitable manner, such as in the form of an API request described above. In at least some embodiments, the request is accompanied by a digital signature authenticating the user.

Hot wallet 304 may receive the request and create a raw blockchain transaction from the request. The request may include such as wallet address, recipient, and amount which are encoded as parameters of the raw blockchain transaction. The raw blockchain transaction, as noted above, may lack a digital signature signed by the hot wallet's private key, which is accessible from within the secure enclave 306 (e.g., not accessible to hot wallet 104 or the portion thereof running outside of the protected execution environment). Hot wallet 304 may send the raw blockchain transaction to the enclave 306.

Secure enclave 306 may receive the raw blockchain transaction from hot wallet 304 and extract transaction semantics. The transaction semantics may include some or all of the following information from the raw blockchain transaction: blockchain ID, token address, wallet address, recipient address, and amount. Secure enclave 306 may retrieve wallet private key and security policies based on the blockchain ID and wallet address. For example, a key-value pair may be used to store and retrieve security policies using blockchain ID and wallet address pair as a key and security policy for the wallet as values. Secure enclave 306 may evaluate the transaction semantics against one or more wallet-specific security policies, one or more global security policies, or a combination thereof. A wallet-specific security policy may have a binding that associates it to a specific wallet, whereas a global security policy may be applicable to all wallets within a blockchain network. In some cases, group policies may be applicable to sets of wallets.

In at least some embodiments, security policies can encode various restrictions. In at least some embodiments, wallet policies may include whitelists and/or blacklists of token addresses, recipient addresses; limit to amount of non-fungible tokens that can be transferred (e.g., over a predetermined period of time); trusted time based policies such as daily limit, weekly limit, etc.; count based limit such as daily transaction limit; and any combination thereof. In at least some embodiments, global security policies may encode whitelists and/or blacklists of blockchain identifiers, token addresses, wallet addresses, recipient addresses; amount limit; time based limit; count based limits; and any combination thereof. Examples of wallet-specific and global security policies described above are merely illustrative and are not necessary exclusive to one or the other.

If all applicable security policies are satisfied, then secure enclave 306 may use wallet private key to digitally sign the raw blockchain transaction and provide the raw blockchain transaction to hot wallet 304. Hot wallet 304 may broadcast the wallet signature and raw blockchain transaction to any suitable blockchain network such as blockchain 308, and may notify the user of the result and/or status of the broadcasted blockchain transaction.

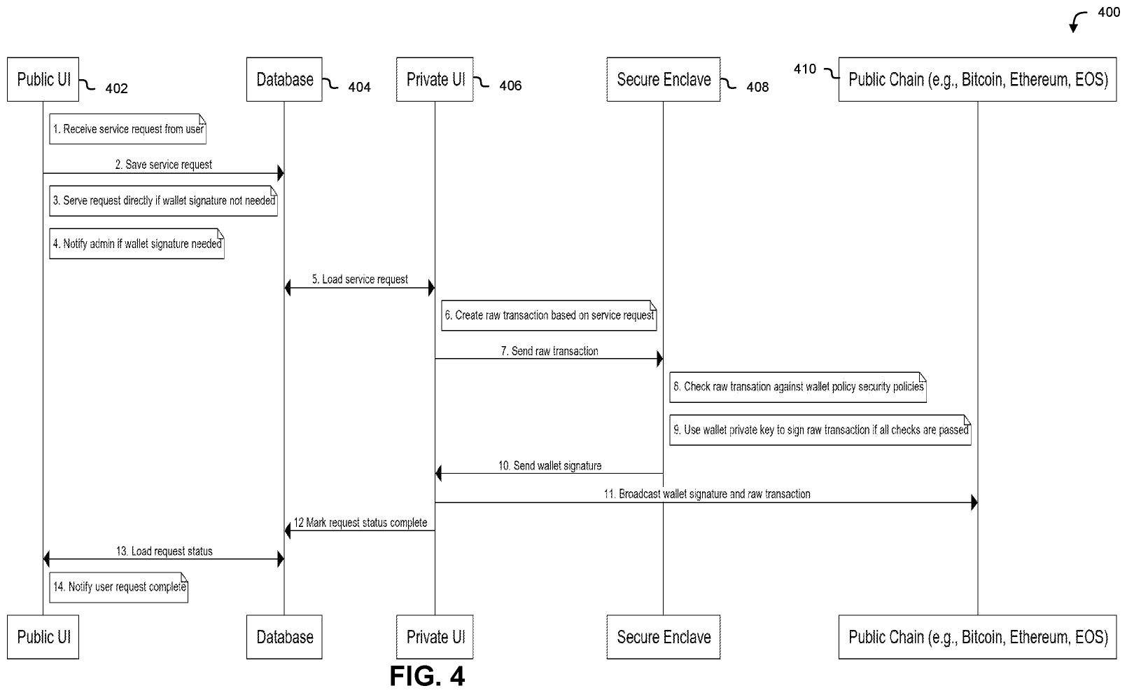

FIG. 4 illustrates a diagram 400 in which various embodiments may be practiced. FIG. 4 illustrates a diagram of blockchain hot wallet based on network isolation, in accordance with at least one embodiment. FIG. 4 illustrates a public user interface (UI) 402, database 404, private user interface (UI) 406, secure enclave 408, and blockchain network 410. In at least some embodiments, techniques described in connection with FIG. 4 may be implemented in the context of embodiments described elsewhere in this disclosure, such as those discussed in connection with FIGS. 1-3, 19, and 20. Techniques described in connection with FIG. 4 may be used to prevent or reduce the impact of web-based attacks to attack blockchain users. For example, attacks involving SQL injections, cross site request forgeries, cross site scripting, attacking weak admin passwords, and other attacks which can result in taking over admin privileges from public UI may be mitigated using techniques described herein below.

Public UI 402 may refer a user interface that may be used by an end-user to interact (e.g., indirectly) with blockchain network 410. For example, public UI 402 may include a command line interface or graphical user interface (GUI) which a user can use to submit requests to execute blockchain transactions for use on blockchain network 410. The public UI's requests may be routed to or executed at least in part by secure enclave 408. In some cases, an end user utilizing public UI 402 may be a malicious actor that attempts to use the UI for illegitimate purposes, such as to inject malicious code to control or disable a backend system. Techniques described herein may harden computer systems and networks from such types of attacks. For example, if public UI 402 is under the control of a malicious user that attempts to disable or damage a backend system, the damage may be limited to the database 404 which the public UI interacts with. Disabling of or destruction of a database 404 may be less costly—measured in terms of financial and/or impact—and may be easier to repair or mitigate than if the damage were directed towards the private UI 406 or downstream components. Public UI 402 may be a client of a computing resource service provider. In at least one embodiment, user requests can be serviced directly, in which case the public UI may be able to fulfill requests directly, rather than through the use of a database which makes the request available to a private UI for fulfillment. In some embodiments, an admin is notified if wallet signature is needed.

Database 404 may refer to a database system or a database service. Database 404 may generally refer to various types of structured data stores, which may be implemented in the context of a computing resource service provider where public UI 402 submits web API requests to a frontend service of a computing resource service provider and the frontend authenticates and/or authorizes the request before providing it to a backend database service for fulfillment. Database 404 may be implemented at least in part using a SQL server. In at least some embodiments, database 404 stores one or more database tables that are configured to store records of request entries. For example, requests from multiple clients may be aggregated in the database 404 and processed in a first-in-first-out (FIFO) manner by private UI 406. The database 404 may store records as structured data that includes a set of fields which are either optional or required. A record may include, for example, requestor and/or request data. For example, public UI 402 may submit a request to transfer an amount of digital assets from a blockchain wallet to another blockchain user. The request may be submitted in the form of a web API request and routed to a database where it is stored as a record with a set of fields that encodes the blockchain ID, hot wallet, recipient blockchain address, digital asset address, amount, or any suitable combination thereof. While a database is illustrated in the context of FIG. 4, other types of data storage systems may be utilized to store and access request data. For example, a queue or stack may be used to access request data in a linear FIFO or LIFO manner.

Database 404 may be populated with requests submitted by clients such as public UI 402. The database may also be accessible to private UI 406. Private UI 406 may have access to private interfaces, protocols, etc. to communicate with database 404. In some embodiments, public UI 402 communicates with database 404 using a client SDK over a public network such as the Internet and private UI 406 communicates with database 404 via a private connection such as a company intranet. The private UI and/or database may be part of a backend service of a computing resource service provider. Private UI 406 may load service requests from the database. For example, the private UI 406 may request one or more records of a database which are not yet fulfilled. For example, records may include a field that indicates the fulfillment status of the request, which may be populated with various statuses such as “NOT STARTED”, “PENDING”, and “COMPLETED”. The private UI 404 may be implemented, in an embodiment, as part of a hot wallet such as those described in connection with FIG. 1.

Private UI 406 may create a raw blockchain transaction based on a service request. The service request may be based on a database record that encodes parameters or data for a raw blockchain transaction, such as a recipient to transfer an amount of digital assets to. The raw blockchain transaction may be in accordance with those described elsewhere in this disclosure, such as those discussed in connection with FIG. 1. Private UI 406 may send the raw blockchain transaction—for example, along with a digital signature—to secure enclave 408. In some embodiments, private UI 406 invokes an enclave entry point to transition execution to a protected execution environment to sign the raw blockchain transaction. In some embodiments, database 404 aggregates requests across multiple blockchain networks and a plurality of private UIs are used to process requests for different blockchain networks. In an embodiment, each private UI supports a different blockchain network and is able to interpret a database record in accordance with its specific blockchain networks. For example, a first private UI may be used to generate raw blockchain transactions for a Bitcoin-based blockchain network and a second private UI may be used to generate raw blockchain transactions for an Ethereum-based blockchain network.

In some embodiments, public UI 402 and private UI 406 are logically and/or physically isolated from each other so that public UI 402 is not able to communicate directly with private UI 406. Public UI 402 may submits requests to be fulfilled by private UI 406 through the submission of requests to database 404. In some embodiments, private UI 406 is connected to a virtual private network which is used to communicate with database 404 but not public UI 402.

In at least some embodiments, public UI 402 can reach the database 404 over a public network such as the Internet and the database can be accessed by the private UI 406 via an internal network of a computing resource service provider such as a private intranet. The private UI 406 may be accessible only to authorized personnel or computing entities within a computing resource service provider.

Secure enclave 408 may be in accordance with those described elsewhere in this disclosure, such as those discussed in connection with FIG. 19. In at least one embodiment, secure enclave 408 checks the raw blockchain transaction against one or more security policies, such as a wallet-specific security policy that applies to a specific hot wallet. In some embodiments, secure enclave 408 checks whether the raw blockchain transaction matches metadata extracted from the corresponding database record. If all checks passed, enclave 408 may use wallet private key of the hot wallet to sign the raw blockchain transaction and make the digital signature available outside of the protected execution environment. Private UI 406 that submitted the raw blockchain transaction to secure enclave 408 may then broadcast the wallet signature and raw blockchain transaction to blockchain network 410 to be validated, processed, and confirmed. The status of the request may be updated in database 404 at various stage of execution, and the status may be queried via the database by public UI 402.

Embodiments herein relate to techniques and systems for validating blockchain transaction. Some embodiments relate to methods and/or devices implementing secure digital signing techniques. In some embodiments, the secure online signing of transactions blockchain leverages hardware-based encryption to protect the private key and the signing process.

The blockchain is an electronic public replicated ledger in which transactions are recorded. Examples of the blockchain are those involving the cryptographic currency Bitcoin. A blockchain database is implemented by software, which may be referred to as blockchain software, which is executed by computer devices (clients). These computer devices may be referred to as a node or miner and participate in the particular overall system (e.g., digital currency payment system). The data stored in the blockchain is being used for the overall system, e.g., to track payments of digital currency, etc. Generally, the software running on each node maintains a copy/replica of the blockchain data/database. For example, the data stored in the blockchain may include various blockchain data fields that may hold account data, personal data, transaction data, currency values, contract terms, documents, version data, links, pointers, archival data, other data, or any combination thereof. The combination of the blockchain database and the software which maintains it may collectively be referred to simply as a blockchain or a replicated blockchain. The data stored in a blockchain is typically coalesced, collected or grouped together, such as on a quantitative and/or periodic basis, into blocks where each block is coupled or linked, such as in a cryptographic manner, with a prior block forming a chain of blocks which may continue to grow as new data is added. Each of the replicated blockchains communicates with the others via a network, such as the Internet. It will be appreciated that the term network, in addition to referring to the communications medium by which replicated blockchains communicate, may also be used to refer to the collection of blockchain clients which are implementing a particular system using a blockchain database for data storage and other functions, which may also be referred to as a blockchain network, or for example, in the case of the Bitcoin implementation of a blockchain, the Bitcoin network.

The blockchain software further implements particular rules for allowing/validating modifications, e.g., addition of new transactions, to the blockchain database by the operator of the particular client as well as for validating and implementing modifications to the blockchain database received from other clients. These rules are generally defined by the type of system the blockchain network is being used to implement, e.g., a system for payment of digital currency, and are coded into the software. In order to change these rules, the software must be updated.

For example, one implementation of a blockchain network is Bitcoin which is a system for digital payment transactions, which may be referred to as the Bitcoin network. Generally, users wishing to make or receive payments of a digital currency, called Bitcoin, construct transaction messages which document a transaction (e.g., the payee, the payor) the amount to paid/received, source(s) of funds, a script detailing a cryptographic authentication from one or more parties authorized to allocate the funds. The transaction is then submitted to the Bitcoin network for validation to confirm available funds, the authenticity of the payor, etc. Each node of the network receives the transaction and executes the rules implemented by the Bitcoin blockchain software to validate the transaction and ensure the payor has unspent funds (calculated from previous unspent transaction outputs) to cover the transaction and that no one is trying to spend the same Bitcoins twice, and then, if validated, record it in the blockchain database and notify other nodes of the modification thereto.

A blockchain network may include miners and nodes. A node may contain a portion of the blockchain (partial node) or the whole blockchain (full node). The node may be configured to check if new transactions are acceptable, and or for example, to check that number of Bitcoins that currently are available for an address. A miner may be configured as a separate entity or as a node as above (with complete or partial data of the blockchain) that creates new blocks that confirm transactions. The new blocks, if found by a miner, are added to the blockchain and are made available (published) on the nodes. Miners are configured to find the new blocks using an algorithm and earn a reward for found blocks. Miners are thus incentivized and rewarded for their effort via the award of a defined amount of Bitcoins for being the first to complete the validation/blockchain modification process, which, by design is a non-trivial process. A blockchain network may include a plurality of miners, a plurality of nodes, and a plurality of mining nodes, e.g., nodes that are also configured as miners. The plurality of nodes may run node software, the miners may run mining software, and the mining nodes may run a combination of the node and mining software. The term “blockchain client” may be used herein to describe miners, nodes, or mining nodes. The term “blockchain software” may be used herein to describe mining software, node software, or mining node software.

In particular, in the Bitcoin blockchain, a block may only be added by solving a cryptographically defined computation based on the data to be stored in the block, data related to the prior block and an arbitrary value selected by the miner with a result of the computation having to meet specific requirements in order to be accepted. As the necessary computations take time, and it may take many attempts by the miner to achieve a suitable result, in conjunction with the reward for success, the Bitcoin blockchain creates a competitive environment in which miners compete, e.g., using computing power, to be the first to successfully add a new block to the blockchain.

The Bitcoin blockchain operates transparently. Data is transmitted to and readable by all participants in the Bitcoin system. That is, each party in the Bitcoin system, with some exceptions, maintains a copy of the ledger, stored by the blockchain, in which all transactions are recorded, referred to as “full replication.” In the case of Bitcoin, this replicated ledger makes all transaction “open transactions” and viewable by all participants on the blockchain network and is a necessary property required to prevent double spending of Bitcoins, i.e., parties attempting to send the same Bitcoin to multiple parties. This property of visibility of all transactions in the Bitcoin network is also a drawback of a blockchain because it does not allow for the confidentiality of transactions. Every participant in the Bitcoin network has access to every transaction on the blockchain. This facilitates the ability to track digital assets, e.g., Bitcoins. The integrity of transactions recorded in each ledger may be cryptographically protected, i.e. “signed,” via a transacting party's or parties privately held the cryptographic key(s) (i.e., a private key). The transactions of funds from an address may require authorization from one or more parties that may sign, e.g., give authorization, through use of one or more cryptographic keys. In certain transactions, multiple parties may be required to authorize the allocation of funds. For example, for a multi-signature address, two or more parties may be required to authorize allocating funds from the address. Additional, more complex options may require certain conditions to be met for one of the two or more parties to provide authorization. In an example, a multi-signature address may require that two out of three parties authorize transactions, or three out of five, or five out of seven, etc. In a scenario that only a single signature is used, if someone were to steal a blockchain/Bitcoin user's private key, the thief could have all of the information necessary, e.g. the transactional record and a cryptographic key thereto, to be able to see all of the transactions to which the user is a party, and the thief would be able to create transactions using the private key without the true owner of the private key's consent. Multiple signatures, as described above, may help prevent theft by requiring that the transaction is signed by multiple keys and as such require the thief to possess each key in order to authorize transactions.

Using the replicated ledgers of blockchain along with cryptographically linking/chaining the transactions stored therein enables all users to ensure the reliability of the transaction data, i.e. that transactions are recorded accurately and subsequent thereto, protected from alteration, as each user has a copy of all of the transactions and any unintended alterations to a transaction, e.g., via errors or fraudulent activity, are readily detectable via both the cryptographic discrepancies within the chained transactions that would be created as well as the discrepancies that such alterations will create among the various copies of the blockchain ledger.

Some embodiments relate to a secure digital signing system. In some embodiments, the secure digital signing system may include one or more processors, memory, and a secure enclave and an application stored in the memory and executable on the one or more processors, configured to perform the following operations.

In one aspect, a secure hardware device of the secure digital signing system may obtain cryptographic information of a client of a blockchain network. The secure enclave may encrypt the cryptographic information, and the secure hardware device may store the cryptographic information. The secure hardware device may receive a request for a transaction associated with the client from the blockchain network and generate raw transaction data based on the request. The secure enclave may decrypt and load the cryptographic information and sign the transaction using the cryptographic information to generate a signature of the transaction.

The secure hardware device is a hardware component of computing devices. An example of the secure hardware device is Intel SGX, which includes a set of the central processing unit (CPU) instruction codes from Intel that allows user-level code to allocate private regions of memory, called secure enclaves, that are protected from processes running at higher privilege levels. Intel SGX may implement a secure remote computation, secure web browsing, and digital rights management (DRM). Another example of the hardware device is a hardware security module (HSM) is a physical computing device that safeguards and manages digital keys for strong authentication and provides crypto-processing.

In some embodiments, the secure hardware device comprises the secure enclave. In certain embodiments, the secure hardware device is a hardware security module (HSM). In certain embodiments, the secure hardware device is Intel® SGX.

In some embodiments, the cryptographic information comprising a signing rule of the client and a private key of the client. In some embodiments, the signing rule indicates a rule for signing one or more transactions using the private key.

In some embodiments, the signing the transaction using the cryptographic information to generate the signature of the transaction comprises: determining whether the signing rule is satisfied for the raw transaction data; in response to a determination that the signing rule is satisfied for the raw transaction data: signing the transaction using the private key to generate the signature of the transaction, and broadcasting the signature of the transaction in the blockchain network; and in response to a determination that the signing rule is not satisfied for the raw transaction data, denying the request.

In some embodiments, the blockchain network comprises a bitcoin network, a litecoin network, or an ethereum network.

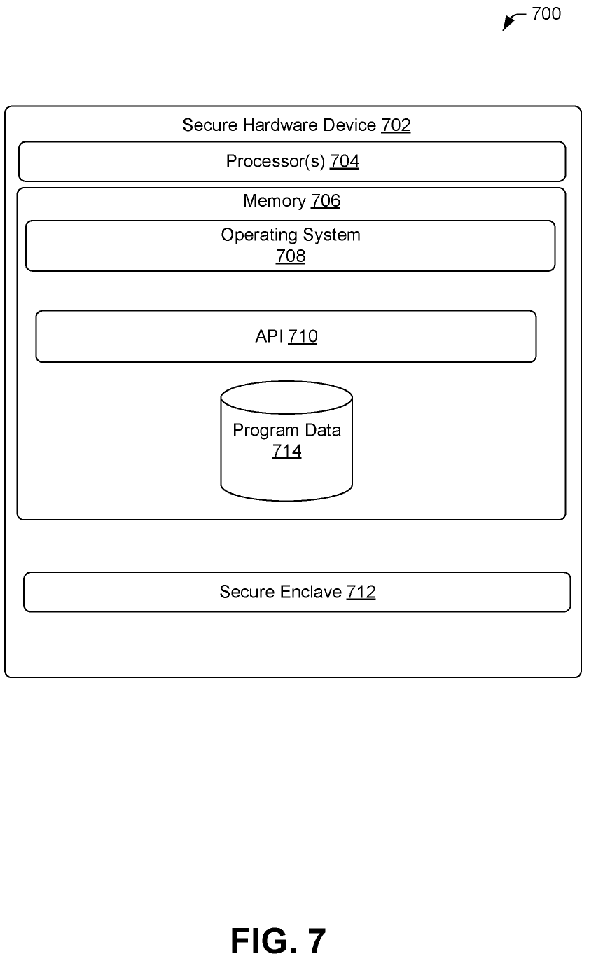

FIG. 7 is a schematic diagram of an illustrative computing architecture 700 to enable provision of risk information associated with compromised accounts. The computing architecture 700 shows additional details of the secure hardware device 702, which may include additional modules, kernels, data, and/or hardware.

The computing architecture 700 may include processor(s) 704 and memory 706. The memory 706 may store various modules, applications, programs, or other data. The memory 706 may include instructions that, when executed by the processor(s) 704, cause the processor(s) 704 to perform the operations described herein for the secure hardware device 702. The processors 704 may include one or more graphics processing units (GPU) and one or more central processing units (CPU).

The secure hardware device 702 may have additional features and/or functionality (e.g., the secure enclave 712). For example, the secure hardware device 702 may also include additional data storage devices (removable and/or non-removable). Computer-readable media may include, at least, two types of computer-readable media, namely computer storage media and communication media. Computer storage media may include volatile and non-volatile, removable, and non-removable media implemented in any method or technology for storage of information, such as computer-readable instructions, data structures, program modules, program data 714, or other data. The system memory, the removable storage, and the non-removable storage are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other medium that can be used to store the desired information and which can be accessed by the secure hardware device 702. Any such computer storage media may be part of the secure hardware device 702. Moreover, the computer-readable media may include computer-executable instructions that, when executed by the processor(s), perform various functions and/or operations described herein.

In contrast, communication media may embody computer-readable instructions, data structures, program modules, or other data in a modulated data signal, such as a carrier wave, or another mechanism. As defined herein, computer storage media does not include communication media.

The memory 706 may store an operating system 708 as well as an API 710. In some embodiments, the secure hardware device 702 of the secure digital signing system may obtain cryptographic information of a client of a blockchain network. The secure enclave 712 may encrypt the cryptographic information, and the API 710 of secure hardware device 702 may store the cryptographic information. The API 710 may receive a request for a transaction associated with the client from the blockchain network and generate raw transaction data based on the request. The secure enclave 712 may decrypt and load the cryptographic information and sign the transaction using the cryptographic information to generate a signature of the transaction.

In at least one embodiment, clause 1 refers to a method of validating a transaction, the method comprising: obtaining, by a secure hardware device, cryptographic information of a client of a blockchain network; encrypting, by a secure enclave associated with the secure hardware device, the cryptographic information; storing, by the secure hardware device, the cryptographic information; receiving, by the secure hardware device, a request for a transaction associated with the client from the blockchain network; generating, by the secure hardware device, raw transaction data based on the request; decrypting and loading, by the secure enclave, the cryptographic information; and signing, by the secure enclave, the transaction using the cryptographic information to generate a signature of the transaction. In at least one embodiment, clause 2 refers to the method of clause 1, wherein the secure hardware device comprises the secure enclave. In at least one embodiment, clause 3 refers to the method of clause 1, wherein the secure hardware device is a hardware security module (HSM). In at least one embodiment, clause 4 refers to the method of clause 1, wherein the secure hardware device is Intel® SGX. In at least one embodiment, clause 5 refers to the method of clause 1, wherein the cryptographic information comprising a signing rule of the client and a private key of the client. In at least one embodiment, clause 6 refers to the method of clause 5, wherein the signing rule indicates a rule for signing one or more transactions using the private key. In at least one embodiment, clause 7 refers to the method of clause 5, wherein the signing the transaction using the cryptographic information to generate the signature of the transaction comprises: determining whether the signing rule is satisfied for the raw transaction data; in response to a determination that the signing rule is satisfied for the raw transaction data: signing the transaction using the private key to generate the signature of the transaction, and broadcasting the signature of the transaction in the blockchain network; and in response to a determination that the signing rule is not satisfied for the raw transaction data, denying the request. In at least one embodiment, clause 8 refers to the method of clause 5, wherein the blockchain network comprises a bitcoin network, a litecoin network, or an ethereum network. In at least one embodiment, clause 9 refers to one or more computer-readable media storing computer-executable instructions that, when executed on one or more processors, perform acts comprising operations of a method of any of clauses 1-8. In at least one embodiment, clause 10 refers to a system for authentication using double-encrypted data, the system comprising: one or more processors; memory; and a secure enclave and an application stored in the memory and executable on the one or more processors, configured to perform a method of any of clauses 1-8.

This document describes techniques for various blockchain-related inventions that utilize secure enclaves. In one embodiment, a hot wallet with secure enclave is implemented to support multi-signature authorization in which a quorum of two or more signers are required to authorize the generation of a digital signature over a blockchain transaction which allows the blockchain transaction to be properly validated, processed, and confirmed on a blockchain network. In one embodiment, a command such as an administrative command is implemented to support multi-signature authorization in which a quorum of two or more admins are required to authorize the execution of the command. In one embodiment, a hot wallet with secure enclave is implemented to support global and user-specific policies that enforce a set of conditions on how the hot wallet can be used. In one embodiment, a hot wallet with secure enclave is implemented with network isolation such that a malicious user is physically and/or isolated from the hot wallet, making it difficult or impossible to perform computer-based attacks on the hot wallet.

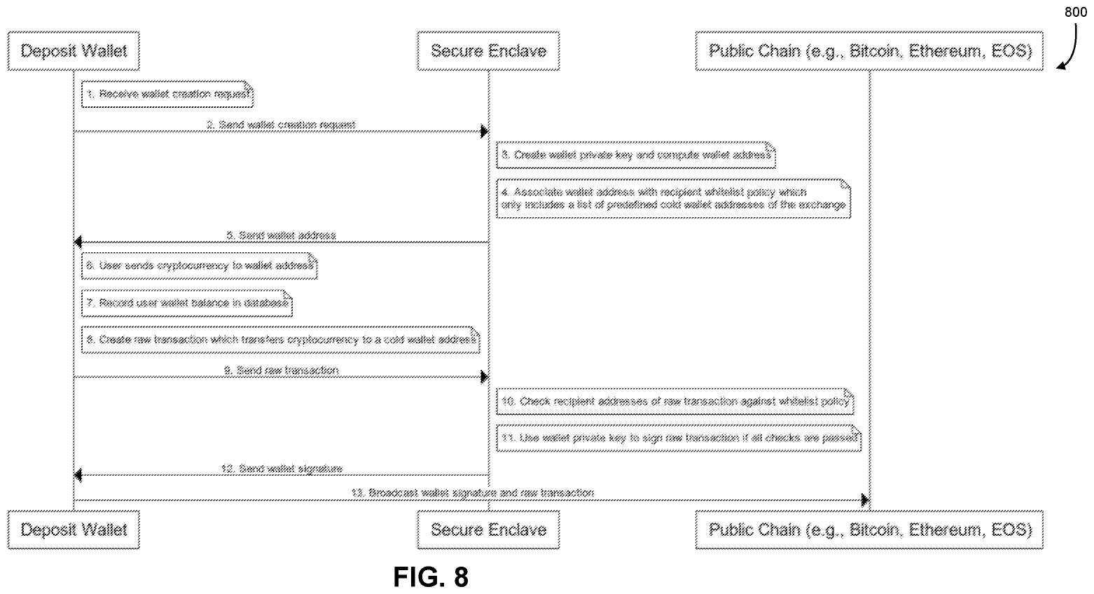

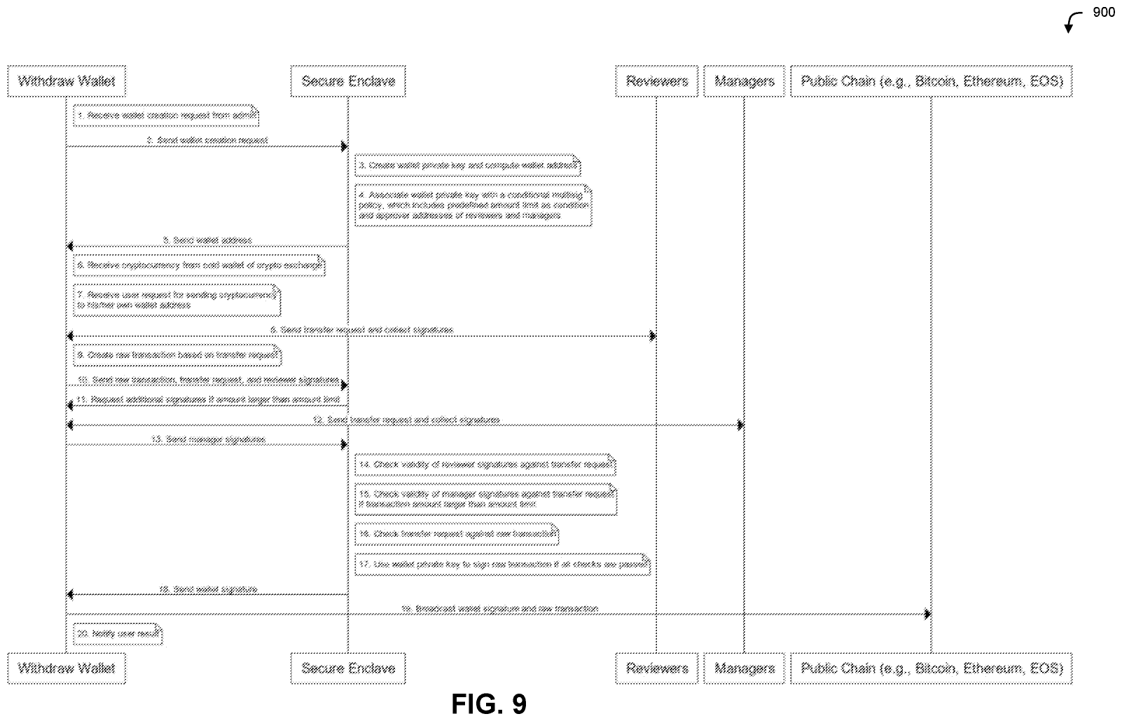

FIG. 8 illustrates a diagram 800 of secure deposit hot wallet of cryptocurrency exchange with secure enclave, according to at least one embodiment. A cryptocurrency exchange may refer to platforms and services that a user can use to exchange digital assets from one type to another. For example, a user of a cryptocurrency exchange may deposit an amount of Bitcoin and exchange it for another type of cryptocurrency (e.g., Ethereum) or other currency (e.g., US dollars). Techniques (e.g., implementation of systems and methods) described in connection with FIG. 8 may be utilized in conjunction with embodiments described elsewhere in this disclosure, such as those discussed in connection with FIG. 9.

In at least one embodiment, a deposit wallet receives a wallet creation request. Wallet creation request may involve associating a private key to a deposit wallet. The private key may be used to digitally sign raw blockchain transactions which can be used by a user to interact with a blockchain network. The blockchain network may be any suitable blockchain network, such as proof-of-work blockchain networks described herein (e.g., Bitcoin, Ethereum). For example, the private key can be used to digitally sign a raw blockchain transaction that is validated by the blockchain network and, upon validation, transfers control of a digital asset from the deposit wallet to another wallet of the blockchain network. In some cases, a user (e.g., human) provides entropy data as part of wallet creation that is introduces an element of randomness to wallet creation process—for example, a user may randomly move a pointing device (e.g., mouse, touch interface) around a graphical user interface (GUI) and the coordinates of the pointing device movement are recorded and provided to the secure enclave as a part of wallet creation. Deposit wallet may be a hardware, software, or a combination thereof. Deposit wallet may include executable code that runs outside of a protected execution environment.

In some cases, the request to create a deposit wallet is to be approved by an admin or a group of admins. In some embodiments, one or more admins contribute digital signatures to a multi-signature authorization scheme in which the secure enclave verifies that a quorum of admins authorizes the creation of the deposit wallet. A deposit wallet may receive the wallet creation request, send the wallet creation request to one or more approvers, and receive approver digital signatures(s) from the one or more approvers. Approvers may, be any suitable computing entity, such as admins of a cryptocurrency exchange.

Deposit wallet may send the wallet creation request to a secure enclave. In some cases, the request includes entropy information to prevent replay attacks or deterministic efforts to re-create a private key. In at least some embodiments, the deposit wallet calls a pre-defined enclave entry point API function to create a blockchain wallet. The enclave entry point may transition execution of a program from a non-protected execution environment (e.g., deposit wallet) to a protected execution environment (e.g., secure enclave). In some embodiments, secure enclave determines a wallet private key by creating the wallet private key, obtaining a pre-generated wallet private key (e.g., one that has been pre-created but not yet used), or any other suitable manner in which private keys can be determined.

Secure enclave of FIG. 8 may be an example of a protected execution environment. Data from outside of the protected execution environment (e.g., parameters for creating a wallet private key) may be accessible from the protected execution environment. In at least some embodiments, secure enclave has access to memory of the deposit wallet that stores parameters for wallet creation. The secure enclave may detect a request to create a blockchain wallet and create the wallet private key and compute a wallet address from the wallet private key. A blockchain wallet may be associated with a blockchain address controlled by the deposit wallet.

A secure enclave (or any other suitable protected execution environment) may associate a wallet address with recipient whitelist policy. In at least some embodiments, the recipient white list policy includes only a list of predefined cold wallet addresses of a cryptocurrency exchange. The deposit wallet and the cold wallet may be controlled by the same entity or organization. In some cases, the private key for the deposit wallet and cold wallet may be simultaneously accessible by a security enclave, although in some cases separate protected execution environments isolate private keys of the deposit wallet from those of the cold wallet, which may be used as an additional security measure to ensure that if one protected execution environment is comprised, it does not follow that the other protected execution environment is also compromised. In at least some embodiment, the deposit wallet cannot unilaterally modify the wallet whitelist—this may be designed such that if the deposit wallet is hacked, a malicious actor is not able to unilaterally transfer digital assets of the deposit wallet to any arbitrary blockchain address. Likewise, a rogue employee with legitimate privileges to receive digital wallets at a deposit wallet of an organization is not able to unilaterally transfer away digital assets that were sent to the deposit wallet. Accordingly, the recipient whitelist policy can be used to limit the blast radius of deposit wallets being compromised because the deposit wallet, in at least some embodiments, is only able to transfer digital assets to a pre-defined list of cold wallets of friendly entities and attempts to transfer digital assets of the deposit wallet to a malicious entity will fail.

In at least some embodiments, secure enclave sends the wallet address to the deposit wallet. Sending the wallet address from the secure enclave to the deposit wallet may include transferring or copying data (e.g., wallet address and/or wallet public key) that is/was stored in enclave memory (e.g., private memory inaccessible to the enclave) to memory outside of the protected execution environment (e.g., as application memory). The deposit wallet or a user of the deposit wallet may share the wallet address with other users of the blockchain network. For example, other users may receive the wallet address and submit blockchain transactions to transfer digital assets to the wallet address as the recipient address. For example, clients of a cryptocurrency exchange may transfer digital assets to a deposit wallet of the exchange, wherein the exchange then holds the digital assets on behalf of its clients and may be used to perform various other exchanges (e.g., exchange the digital asset for digital assets of a different chain, off-chain goods or services, and more).

In at least some embodiments, the deposit wallet records the user wallet balance in a database. For example, the database may be structured data that stores data for balances of users of a cryptocurrency exchange. For example, when a user deposits an amount of fungible tokens, that user may be entitled to withdraw that amount of value in various forms, such as by withdrawing an equal amount in value as fungible tokens of another blockchain network (e.g., deposit BTC and withdraw ETH) or even make a withdraw in off-chain assets, such as US dollars. The database may be maintained and updated as users make other deposits and/or withdraws.

In at least some embodiments, deposit wallet creates a raw blockchain transaction that encodes a transfer of digital assets (e.g., fungible tokens) from the deposit wallet to a cold wallet address. The raw blockchain transaction may lack a digital signature which a blockchain network uses to validate blockchain transaction—the digital signature may be generated using the wallet private key stored in the secure enclave.

The deposit wallet may send the raw blockchain transaction (e.g., as described above) to secure enclave. In some cases, the raw blockchain transaction may be sent to the secure enclave alongside a transfer request, one or more approver signatures, or variations thereof. In at least some embodiments, the raw blockchain transaction is a transfer transaction that sends digital assets of the deposit wallet to a cold wallet address. The deposit wallet and cold wallet may be controlled by the same entity. For example, the deposit entity may be controlled by an organization (or an employee thereof) and the same organization controls the cold wallet. The cold wallet may be used to aggregate digital assets from multiple deposit wallets. Deposit wallet may invoke an enclave entry point API to send the raw blockchain transaction to the secure enclave.

Secure enclave may obtain the raw blockchain transaction information in the protected execution environment. The secure enclave may perform one or more validation checks on the raw blockchain transaction. For example, one check may be to use a security policy (e.g., those described elsewhere in this document or those incorporated by reference herewith) that encodes a whitelist and/or blacklist of blockchain addresses. A whitelist may refer to a list of blockchain addresses which certain types of blockchain transactions must set—for example, a whitelist may require that a blockchain transaction set all recipient blockchain addresses from the whitelist, wherein if even one among several recipient addresses is not listed in the whitelist, the blockchain transaction fails the validation check and the secure enclave refuses to digitally sign such blockchain transaction. Conversely, a blacklist may be used in a computing environment wherein inclusion of any address included in the blacklist causes a validation check to fail.

Secure enclave may check validity of one or more approver signatures using any suitable signature verification routine. For example, the secure enclave may receive a first message and a first approver signature purportedly generated over the first message using the private key of the first approver. The secure enclave may generate a second message using the first approver signature and corresponding public key of the first approver. If the first message and the second message match, the digital signature is considered valid. These steps may be repeated for each approver signature and corresponding approver public key. The blockchain transaction may be valid if the secure enclave verifies that all approver signatures (or a sufficient quorum thereof) are valid.

In at least some embodiments, as a result of successful validation of one or more validation checks, the secure enclave may use the wallet private key (e.g., same wallet private key created above, associated with the deposit wallet) to digitally sign the raw blockchain transaction. The digital signature may be a type of cryptographically verifiable attestation of authorization to perform actions (e.g., transfer digital assets) encoded in the raw blockchain transaction. The digital signature may be generated over a raw blockchain transaction that is generated by the secure enclave or one that is provided by the deposit wallet.

The secure enclave may send the wallet signature to the deposit wallet, for example, through a specific enclave API. In at least some embodiments, the deposit wallet broadcasts the wallet signature and raw blockchain transaction to blockchain network. Nodes of the blockchain network may use a public key associated with the deposit address to verify that the wallet signature and raw blockchain transaction are valid, and process the raw blockchain transaction accordingly. For example, a balance of digital assets may be transferred from the deposit wallet to a cold wallet that is included in the whitelist described above, as a result of processing the raw blockchain transaction.

FIG. 9 illustrates a diagram 900 of secure withdrawal wallet of cryptocurrency exchange with secure enclave, according to at least one embodiment. Techniques (e.g., implementation of systems and methods) described in connection with FIG. 9 may be utilized in conjunction with embodiments described elsewhere in this disclosure, such as those discussed in connection with FIG. 8.

A withdraw wallet may receive a wallet creation request from an admin. In some cases, the wallet creation request includes a digital signature that attests the admin approves of the wallet creation. In some embodiments, the withdraw wallet submits the wallet creation request to other admins of the system for approval and those admins contribute additional digital signatures. When a quorum of digital signatures indicate approval to create the withdraw wallet, the withdraw wallet may submit a request to the secure enclave to create the withdraw wallet. In some cases, a digital signature from a single admin (e.g., admin submitting wallet creation request to withdraw wallet) is sufficient.

The withdraw wallet may send a wallet creation request to a secure enclave using an enclave entry point. The request may, in some embodiments, include a plurality of digital signatures indicating approval by a quorum of admins to create the withdraw wallet. The secure enclave may receive a plurality of digital signatures and cryptographically verify the authenticity and integrity of the digital signatures. Upon successfully verification of the authenticity and integrity of a quorum of admin digital signatures, the secure enclave may determine that a satisfactory indication of authorization to create the wallet has been provided. The withdraw wallet may be used by a cryptocurrency exchange to distribute digital assets to one or clients. For example, a client of the exchange may transfer digital assets on one chain to the cryptocurrency exchange in exchange for digital assets from another chain.

Secure enclave may create a wallet private key and compute a corresponding wallet address from the wallet private key. In some cases, the wallet address can be used to determine a wallet public key corresponding to the wallet private key. The withdraw wallet may be used by a cryptocurrency exchange to distribute digital assets to clients of the exchange. For example, clients of the exchange may deposit fungible tokens and at a later point in time, withdraw fungible tokens of equal value (e.g., from same or different chain) at a later point in time. In at least some embodiments, techniques described in connection with FIG. 9 are used to prevent or limit the harm that can be done if a hacker is able to gain control of a withdraw wallet. For example, a hacker that gains control of a withdraw wallet may attempt to transfer out digital assets of the withdraw wallet but fail to do so because an approver (e.g., reviewer and/or manager) detects that the hacker's requested transfer is unauthorized and refuses to approve it.

The secure enclave may associate the wallet private key to a security policy, for example, through a key-value mapping wherein private keys are used as keys in the mapping and security policies are the values. In some embodiments, the secure enclave creates a wallet private key and associates that key with a conditional multi-signature authorization policy which requires a quorum of digital signatures by approvers. Approvers may be admins, reviewers, managers, etc. of an organization that controls digital assets of a cold wallet and also control the withdraw wallet (e.g., through a subsidiary or a subordinate employee). Accordingly, the recipient whitelist policy can be used to limit the blast radius of withdraw wallets being compromised because the withdraw wallet, in at least some embodiments, transferring digital assets out of the withdraw wallet may be throttled or otherwise subject to approval by reviewers or admins, who may be able to inspect the withdraw requests and deny those requests which are illegitimate (e.g., attempts by malicious entities to steal digital assets from a compromised withdraw wallet).

In some embodiments, the security policy associated with a withdraw wallet is a multi-tiered security policy wherein the manner in which authorization to withdraw digital assets is performed varies based on the amount being withdrawn (e.g., in the case of fungible tokens and/or non-fungible tokens with defined values). For example, a security policy may have a predefined limit as a condition and a quorum of approver signatures are required if the withdraw amount in a raw blockchain field exceeds that limit. Approvers may be admins, reviewers, managers, combinations thereof, and more. Each approver may have a corresponding private key that the secure enclave has access to—perhaps from a digital signature that is signed directly or indirectly (e.g., via a chain of trust) by a certificate authority which is trusted by the secure enclave.

The secure enclave may send wallet address to the withdraw wallet and indicate that the withdraw wallet was successfully created. In some embodiments, the withdraw wallet receives digital assets (e.g., fungible tokens) from a cold wallet of a cryptocurrency exchange. The withdraw wallet may receive user request for sending digital assets (e.g., non-fungible tokens) to the user's own wallet address. Cold wallets may periodically distribute digital assets to a plurality of withdraw wallets, but otherwise remain offline as a security precaution that makes digital assets of the cold wallet inaccessible, thereby reducing or eliminating avenues for electronic-based attacks by malicious parties to gain access to digital assets of the cold wallet(s). Withdraw wallets may be hot wallets which cold wallets periodically distribute digital assets (e.g., fungible tokens) to. The withdraw wallets may have fixed or maximum amounts of digital assets which the cold wallet distributes. Withdraw wallets may be used to limit the blast radius of electronic attacks, wherein a malicious actor gaining access to a first wallet private key of a first withdraw wallet does not affect a second withdraw wallet and keeps the digital assets of the second withdraw wallet safe.

The withdraw wallet may send a transfer request to approvers (e.g., reviewers and/or managers) to approve the transfer request. In at least some cases, an approver indicates approval of a request by generating an approval message as a digital signature over the request. In some cases, the approval message is signed with a timestamp, nonce, or other information as a security measure. In at least some embodiments, a quorum of approval messages and/or approver digital signatures are required for the secure enclave to process a transfer request. The transfer request may be initiated by a user, such as a client of a cryptocurrency exchange that is requesting to withdraw the user's funds from the exchange to a wallet address that the user controls.

Transfer requests may require various levels of approval, which can be based on various factors such as the amount being requested. In some cases, if a withdraw request is submitted from a specific geolocation (e.g., from specific states or countries which have had a historical record of incidents of fraudulent requests), higher levels of approval may be required. In some cases, regulatory rules of certain states may be evaluated to determine whether to seek higher levels of approval. In some cases, network address information may be used. In some cases, whether a multi-factor authentication (MFA) of the requestor's identity was used may be a factor in determining what level of approval is required. In some embodiments, different levels of approval have different levels of involvement by approvers. For example, as a lowest level, a request for a small amount of digital assets that is accompanied by a successful multi-factor authentication may not require approver digital signatures. In some embodiments, a withdraw request for a large amount of a user's digital assets from the cryptocurrency exchange (e.g., relative to the user's balance or an absolute threshold) may indicate a higher level of approval is required. In some embodiments, different levels of approval are required for different amounts being withdrawn—for example, for amounts up to A, approval may be performed by a reviewer, wherein the reviewer is a front-line employee of an organization. For amounts between A and B, a manager (e.g., manager or supervisor of the reviewer) may be required to generate an approval signature for the withdraw request. Higher levels of authorization (e.g., by employees with greater levels of responsibility) may be required for higher withdraw amounts, and so on. Note that these are merely non-limiting illustrative examples of how different types of signature schemes may be implemented and other embodiments are contemplated, as described in greater detail elsewhere in this disclosure.

Withdraw wallet may create a raw blockchain transaction based on the transfer request. For example, the user may specify a user wallet address and amount of fungible assets to transfer. The amount, in some cases, must be less than or equal to an amount of value that the user had previously deposited to a deposit wallet, such as those described in connection with FIG. 8. In some cases, deposits and withdraws made by a user to a cryptocurrency exchange are tracked in a database which tracks deposit and withdraw amounts, the addition and subtraction (respectively) of which results in the user's balance. As described above, transfer request may require the user to perform a MFA process or other authentication processes.

Withdraw wallet may submit the raw blockchain transaction, transfer request, and approver signatures to the secure enclave. The withdraw wallet may communicate with the secure enclave using an enclave entry point that includes a raw blockchain transaction, transfer request, one or more approver signatures, or suitable combinations thereof.

In some cases, the withdraw wallet requests additional approver signatures to be sent with the request to the secure enclave. In some cases, the withdraw wallet submits a request to sign a raw blockchain transaction and the secure enclave checks the level of approval required, and provides a response with an indication of the level of approval required. The withdraw message may use the response to determine which entities to seek out approver signatures from—for example, the withdraw wallet may use the response to determine whether to send a request to a reviewer and/or manager for an approver digital signature.

In some cases the withdraw wallet requests additional signatures if the amount to be transferred is greater than an amount limit. For example, approver signatures may need to come from managers and/or higher-level supervisors if the withdraw amount exceeds certain limits. Withdraw wallet may send a transfer request and collect digital signatures from one or more approvers, such as managers, whose approval signatures may be required based on conditions encoded in a security policy associated with the withdraw wallet.

A secure enclave may receive a raw blockchain transaction, a transfer request, and collection of approver signatures. A protected execution environment (e.g., secure enclave) may receive data from a non-protected execution environment as parameters to an enclave entry point API command. In some cases, the transfer request is not required—for example, the withdraw wallet may also sign the raw blockchain transaction to provide cryptographically verifiable assurances of authenticity, integrity, non-repudiation, or a combination thereof.

The secure enclave may check validity of approver signatures against the transfer request. The secure enclave may parse the withdraw request (e.g., checking the withdraw amount, IP address of the request) and determine a manner in which to make an authorization check.

In some embodiments, the secure enclave determines that the manner in which to make the authorization check includes determining a quorum of managers approve of the withdraw request. The secure enclave may check validity of a plurality of manager signatures against the transfer request if the transaction amount is larger than an amount limit. If the amount is smaller than the amount limit, the authorization check may be performed in a different manner, for example, verifying that a quorum of digital signatures from any suitable combination of reviewers and managers was presented.

The secure enclave may check a transfer request against a raw blockchain transaction. This step may involve verifying that the amount in the transfer request and the raw blockchain transaction are the same, the recipient information is the same, etc. The secure enclave may perform this check to ensure that the raw blockchain transaction correctly reflects the transfer request. Checking a transfer request against raw blockchain transaction may involve verifying that the parameters of the transfer request are encoded in the raw blockchain transaction. For example, if the transfer request includes a recipient blockchain address, an amount of digital assets to transfer, and so on, those values should be encoded in the raw blockchain transaction for the raw blockchain transaction to be valid. In some embodiments, the secure enclave generates the raw blockchain transaction from the transfer request rather than receiving it from the withdraw wallet via an enclave entry point.

In some embodiments, once all verifications checks are performed and pass, the secure enclave may use the wallet private key to sign the raw blockchain transaction, thereby generating a digital signature which a blockchain network can validate.

Once a raw blockchain transaction is obtained (e.g., generated or received via enclave entry point)—and in at least some cases, validated—the secure enclave may use the wallet private key of the withdraw account to digitally sign the raw blockchain transaction. In at least some embodiments, the digital signature generated over the raw blockchain transaction is an attestation that the withdraw wallet authorizes the raw blockchain transaction and is used by nodes of the blockchain network to validate that the raw blockchain transaction should be processed. The secure enclave may send the wallet signature and the raw blockchain transaction to the withdraw wallet. In some cases, the secure enclave provides only the wallet signature to the withdraw wallet, such as in embodiments where the withdraw wallet retains a copy of the raw blockchain transaction which can be associated with the wallet signature it receives from the secure enclave.

The withdraw wallet may broadcast the wallet signature and raw blockchain transaction to a blockchain network. The blockchain network may receive the raw blockchain transaction and wallet signature, validate the wallet signature, and process the raw blockchain transaction. In some embodiments, processing of the blockchain transaction by nodes of the blockchain network results in control of one or more digital asset being transferred from the withdraw wallet to a user wallet.

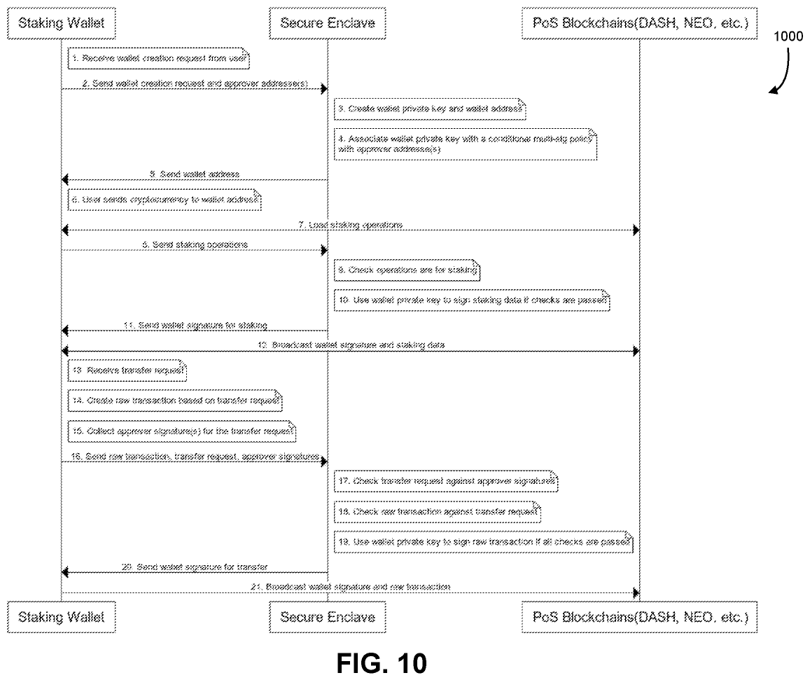

FIG. 10 illustrates a diagram 1000 of secure staking wallet with secure enclave, according to at least one embodiment. FIG. 10 illustrates a staking wallet, secure enclave, and proof-of-stake (POS) blockchain network, which may be in accordance with the same or similar to those described elsewhere in this disclosure. Non-limiting examples of proof-of-stake (POS) blockchain networks include DASH, NEO, etc. In contrast, examples of proof-of-work (POW) blockchain networks include Bitcoin, Ethereum, etc. POS blockchain network illustrated in FIG. 10 may be in accordance with those described in greater detail elsewhere in this disclosure.

Staking may refer to an operation in which a blockchain user uses his/her wallet to earn rewards by mining new blocks. A user may stake an amount of digital assets (e.g., fungible tokens) to the staking wallet such that the user's digital assets are locked and in exchange the user is allowed to participate in the POS blockchain network. The user may, at a later point in time, withdraw the staked digital assets from the staking wallet, after which the user is no longer allowed to participate in the mining process of the POS blockchain network.

In some embodiments, the staking wallet may send a wallet creation request and approver addresses to the secure enclave. The approver addresses may be a predetermined list of blockchain addresses which are chosen as approvers to review and approve withdraw requests.

The secure enclave may create the wallet private key and the wallet address. The wallet private key—alternatively referred to as a staking private key in this context—may be created and associated with the staking wallet using techniques described elsewhere in this disclosure. The secure enclave may create the wallet private key and associate the wallet private key with a security policy that encodes a conditional multi-signature policy with one or more approver addresses. The conditional multi-signature policy may indicate that a quorum of approver signatures are required to perform certain operations. For example, the conditional multi-signature policy may be applicable only to requests to withdraw digital assets (e.g., fungible tokens) from the staking wallet. In some embodiments, a whitelist policy is used to restrict the staking wallet such that it can only transfer digital assets to wallet addresses in the whitelist (e.g., only to the user).

The secure enclave may send the wallet address to the staking wallet. In some embodiments, a status code is provided by the secure enclave to a wallet in response to a wallet creation request. The staking wallet may receive the wallet address and distribute the wallet address to users joining a POS blockchain network. Users may send digital assets (e.g., cryptocurrency) to the staking wallet address. When a user stakes digital assets to the staking wallet, the user may be granted access to participate in a POS blockchain network (e.g., mining). The user may runs the staking wallet on his/her own computer system or a server machine.

The staking wallet may load staking operations with the proof-of-stake blockchain network. The staking wallet may send staking operation to the secure enclave. An example of a staking operation is an operation to validate (e.g., mine) a block to the POS blockchain network. The staking wallet may send the staking operation to the secure enclave via an enclave entry point API or use any other suitable technique described herein to transition from a non-protected execution environment to a protected execution environment.

The secure enclave may verify that the requested operation is for staking. Continuing with the example described above, if the staking wallet is contributing a block to the POS blockchain network, a conditional multi-sig policy may not apply, and the enclave may use the wallet private key to sign the staking data without requiring a multi-signature authorization process. In some embodiment, other checks are performed, such as verifying whether parameters encoded in a message match field values of a raw blockchain transaction. If all verification checks pass, the secure enclave may use the wallet private key to sign the staking data, thereby generating a wallet signature for staking.

The secure enclave may send wallet signature for staking to the staking wallet, and the staking wallet may provide the staking data and the wallet signature to the POS blockchain network. The POS blockchain network may verify authenticity of the digital signature and broadcast the block to other nodes of the POS blockchain network.

FIG. 10 also illustrates a restricted staking wallet operation that requires multi-signature authorization from approvers. In an embodiment, the staking wallet may receive a transfer request to transfer some or all digital assets in the staking wallet to a user (e.g., the user that had sent digital assets to the wallet address or, in some cases, a different user).

The staking wallet may create a raw blockchain transaction based on the transfer request, which may encode an amount to withdraw, a recipient wallet address, and so on. Additional fields, such as a nonce, may also be included. The staking wallet may determine that the requested operation (e.g., transfer request) is a restricted operation and in response, collects one or more approver signatures according to the conditional multi-signature authorization policy described above. For example, the staking wallet may send requests to approvers and collect a quorum of approver signatures.

The staking wallet may send the raw blockchain transaction, transfer request, and a quorum of approver signatures to the secure enclave. The secure enclave may check that the conditional multi-sig policy applies to the transfer request and verify validity of the approver signatures. The secure enclave may check the raw blockchain transaction against the transfer request using techniques described herein. If all checks pass, the secure enclave may use the wallet private key to sign the raw blockchain transaction. The secure enclave may send the wallet signature to the staking wallet and the staking wallet may broadcast the wallet signature and raw blockchain transaction to the proof-of-stake blockchain network. The wallet signature and raw blockchain transaction may, as a result of being validated and processed, cause staked digital assets (e.g., the initial deposit plus rewards earned by participating in the POS blockchain network) to be transferred to the user that had initially staked the deposit.

In some embodiments, all staking-related operations are protected by conditional multi-sig to prevent harm from malicious actors that are able to gain access to the staking wallet. For example, in some POS blockchain networks, nodes are allowed to participate in a voting mechanism wherein nodes that vote with the majority receive a share of a reward and nodes in the minority are punished for voting incorrectly by having a share of their deposit revoked (e.g., distributed to voters in the majority). This may be an incentive for nodes in a POS blockchain network to perform a task correctly and vote for the correct output or answer. Accordingly, in some embodiments, voting operations are protected by a conditional multi-sig policy so as to prevent malicious actors from draining a staking wallet's deposit by voting incorrectly.

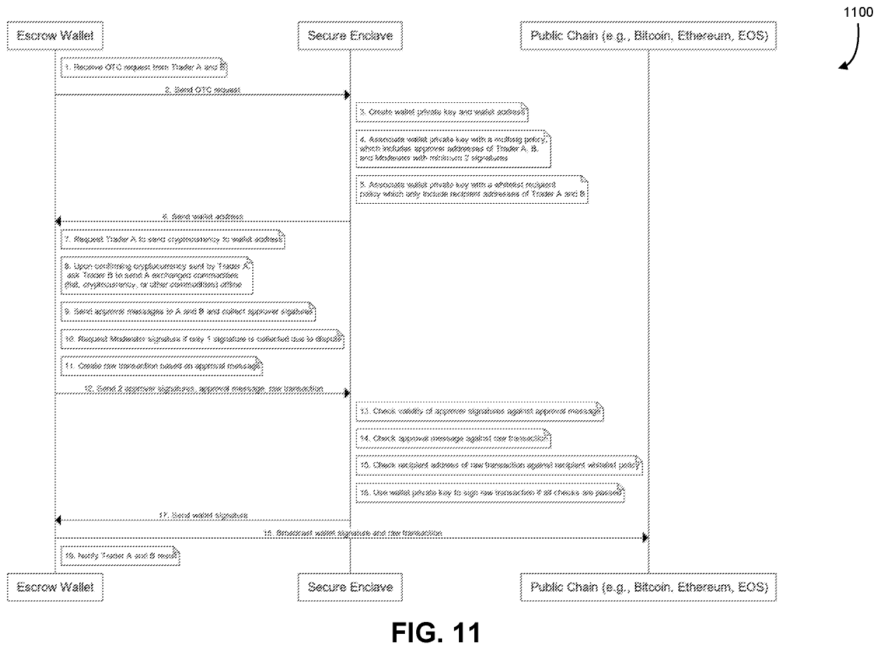

FIG. 11 illustrates a diagram 1100 of secure off-chain exchange with secure enclave, according to at least one embodiment. FIG. 11 illustrates an escrow wallet, secure enclave, and blockchain network, which may be in accordance with the same or similar to those described elsewhere in this disclosure. Note that “off-chain” in this context may refer to an exchange of value between two or more entities (e.g., at least two transfers—one transfer from party A to party B and another transfer from party B to party A) wherein at least a first transfer occurs on a blockchain network and a second transfer occurs off the blockchain network. Examples of the off-chain transfer can include a transfer of digital assets (e.g., fungible tokens) on a different blockchain network (e.g., a first transfer on a Bitcoin-based network such as Bitcoin Cash and a second transfer on an Ethereum-based network). An off-chain exchange may be referred to as an OTC (off-the-chain) exchange. An off-chain exchange may involve an exchange of digital assets over two or more blockchains (e.g., a cross-chain exchange may be a specific type of off-chain exchange).

An escrow wallet may obtain or otherwise receive an exchange request. In at least some embodiments, the request may be between two or more entities. Non-limiting illustrative examples described throughout this disclosure may describe an exchange as being between a first blockchain user A (or Alice) and a second blockchain user B (or Bob). Alice and Bob may have blockchain wallets on a blockchain network, and may furthermore may control digital assets on other blockchain networks, offer off-chain goods and/or services, and the like. For example, Alice may control an amount or value of fungible tokens on a blockchain network that she agrees to transfer to Bob in exchange for off-chain goods or services (e.g., exchange digital assets for a product) which is facilitated using techniques described in connection with FIG. 11. An escrow wallet may be in accordance with other blockchain wallets described herein. In some embodiments, the escrow wallet is created as part of an off-chain exchange protocol—in other cases, the escrow wallet is created beforehand and can be used repeatedly over time by the same two parties to perform off-chain exchanges, such as in the case where two organizations have an ongoing relationship. In some cases, the escrow wallet is controlled by moderator M.

The escrow wallet may submit a request to secure enclave to facilitate an OTC request. The escrow wallet may send the OTC request to secure enclave using an enclave entry point API. The request may include, encode, or otherwise make available the wallet address for two or more wallet addresses that indicate they are participating in the off-chain exchange. The request may include, encode, or otherwise make available the wallet address of a moderator M that is agreed upon by the parties. In some cases, a digital signature by one or more of the off-chain entities is provided as part of the request, which may be validated using the off-chain entities' public keys. For example, the request may include a message that moderator M is agreed upon as an adjudicator, wherein the message is signed by Alice and Bob.

The secure enclave may receive the request, perform one or more verification checks (e.g., check validity of one or more digital signatures) and create a wallet private key which is associated with a wallet address. The wallet private key—which may also be referred to as an escrow private key—may be used to generate digital signatures that can be used to transfer control of digital assets controlled by the escrow wallet. Upon creation, the escrow wallet might not initially control any digital assets (e.g., fungible tokens) but may, as part of an off-chain exchange protocol, receive and send digital assets such as fungible tokens between participants of the off-chain exchange.

As part of setting up the escrow wallet for use, the secure enclave may create the wallet private key and then associate the wallet private key with a multi-signature policy which includes approver addresses of the first blockchain user A, second blockchain user B, and a moderator M wherein the multi-signature requires a quorum of at least two signatures. In some embodiments, a 2-of-3 multi-signature scheme is employed wherein at least two digital signatures from Alice, Bob, and the moderator M are needed.

The secure enclave may associate wallet private key with a whitelist recipient policy. In at least some embodiments, the whitelist includes only blockchain addresses of the first blockchain user A and the second blockchain user B. In some cases, the whitelist includes moderator M. A whitelist may be a policy element which requires that transfers made by a wallet must include recipients enumerated in the whitelist, and attempted transfers to recipients not in the whitelist are rejected (e.g., secure enclave refuses to sign with wallet private key).

The secure enclave may send the wallet address to the escrow wallet. The wallet address may be provided as a response to a request to create an escrow wallet. The wallet address may be distributed to the first blockchain user A and the second blockchain user B. The escrow wallet may send one of the blockchain users (e.g., Alice or Bob) a request to transfer digital assets to the wallet address. The request may be digitally signed using the wallet private key. For example, if Alice receives the request from escrow wallet, then Alice may generate a raw blockchain transaction to transfer digital assets (e.g., an amount of fungible tokens) to the escrow wallet, sign the raw blockchain transaction, and broadcast the raw blockchain transaction and digital signature to a blockchain network; Alice may also send a message to the escrow wallet indicating that the blockchain transaction was broadcasted.

The escrow wallet may confirm that it received digital assets (e.g., fungible tokens) from Alice. The escrow wallet may send a message to another blockchain user (e.g., Bob) that the escrow wallet has control of the digital asset (e.g., that Alice transferred digital assets to the escrow wallet). Bob may use this indication to execute an exchange—for example, Bob may provide Alice with a real-world good or service, such as an exchange of physical value, access to a service (e.g., enter a movie theatre), transfer digital assets of a different blockchain network to Alice, and more. In some embodiments, an off-chain activity or exchange occurs in which Bob provides value (e.g., good or service) to Alice. In some cases, Bob transfers a second digital asset to the escrow wallet or to Alice.

The escrow wallet may (e.g., upon receiving a claim by Bob that an off-chain exchange occurred). The escrow wallet may send approval messages to Alice and Bob and collect approver signatures. In some cases, both approver signatures may be collected, which may be sufficient to authorize a 2-of-3 multi-sig condition on the escrow wallet. If only either Alice or Bob provides an approval signature, then the moderator may determine whether to contribute the second approver signature. For example, the moderator M may instigate and determine whether Bob actually performed an off-chain service which was agreed upon prior to the initiation of the on-chain exchange. For example, if the moderator M agrees with Bob that the off-chain activity is performed, moderator M can sign a request from Bob to transfer the digital assets under the escrow wallet's control to Bob; if the moderator M agrees with Alice that the off-chain activity was not performed, moderator M can sign a request from Alice to return to Alice control of the digital assets that Alice had previously transferred to the escrow wallet.

The escrow wallet may create a raw blockchain transaction based on the approval message. In at least one embodiment, Alice and Bob both generate approval messages that indicates both parties agree that Bob fulfilled his part of the off-chain exchange. In at least one embodiment, the escrow wallet receives both approval messages and generates a raw blockchain transaction with an amount to transfer equal to the value of the digital assets it received from Alice and a recipient address that is Bob's wallet address.

However, in some cases, a dispute may arise in which Alice and Bob do not agree that the off-chain exchange occurred. In the case of a dispute, mediator M can contribute a second approval message to support either Alice's claim or Bob's claim. For example, if the mediator supports Bob's claim, then approval messages from Bob and mediator are sufficient for the escrow wallet to a generate a raw blockchain transaction with an amount to transfer equal to the value of the digital assets it received from Alice and a recipient address that is Bob's wallet address. Likewise, fi mediator supports Alice's claim, then approval messages from Alice and mediator are sufficient for the escrow wallet to generate a raw blockchain transaction that refunds back to Alice the digital assets that she sent to the escrow wallet.

In either case—whether both Alice and Bob agree or if there is a dispute in which mediator M adjudicates, the escrow wallet obtains two approver signatures (e.g., either Alice plus Bob or mediator plus one of Alice or Bob) and sends the approver signatures, approval message, and raw blockchain transaction to secure enclave. Escrow wallet may provide the approver signatures, approval message, raw blockchain transaction, or any suitable combination thereof using an enclave entry point that transitions execution of an application from a non-protected execution environment to a protected execution environment.

The secure enclave may check validity of approver signatures against approval message. For example, the public keys of the approvers and approver signatures may be used to generate outputs which should match the approval message to be valid. In a 2-of-3 multi-signature scheme, at least two valid signatures must be presented to process the blockchain transaction. The approval message may be checked against the raw blockchain transaction to ensure that parameters encoded in the approval message (e.g., value, recipient address) are correctly reflected in the raw blockchain transaction. In some embodiments, the enclave generates the raw blockchain from the approval message rather than receiving the raw blockchain transaction from the escrow wallet. The recipient address of the raw blockchain transaction may be checked against a whitelist policy, such as those described elsewhere in this disclosure. For example, the whitelist may require the recipient address to be either Alice or Bob's wallet address. In some cases, the raw blockchain transaction distributes a first portion of fungible tokens to Alice and a second portion of fungible tokens to Bob, such as in the case of partial performance of a service. In at least some embodiments, all validation checks performed by the secure enclave are satisfied and the wallet private key is used to generate a digital signature over the raw blockchain transaction.

At least the wallet signature may be provided to the escrow wallet. In some cases, the raw blockchain transaction is also returned. The escrow wallet may then broadcast the raw blockchain transaction and the wallet signature to a blockchain network, wherein the raw blockchain transaction is validated, processed, and confirmed by nodes of the blockchain network. In some cases, the escrow wallet notifies Alice and/or Bob of the result of broadcasting of the raw blockchain transaction.

This document describes techniques for various blockchain-related inventions that utilize secure enclaves. In at least one embodiment, a secure hot wallet based on secure enclave and programmable policy enforcement is implemented. In at least one embodiment, blockchain data is securely loaded to secure enclave with multi-signature authorization. In at least one embodiment, secure storage of wallet data and policies is based on secure enclaves, in accordance with at least one embodiment. In at least one embodiment, secure blockchain transaction fee charging is implemented with a secure enclave.

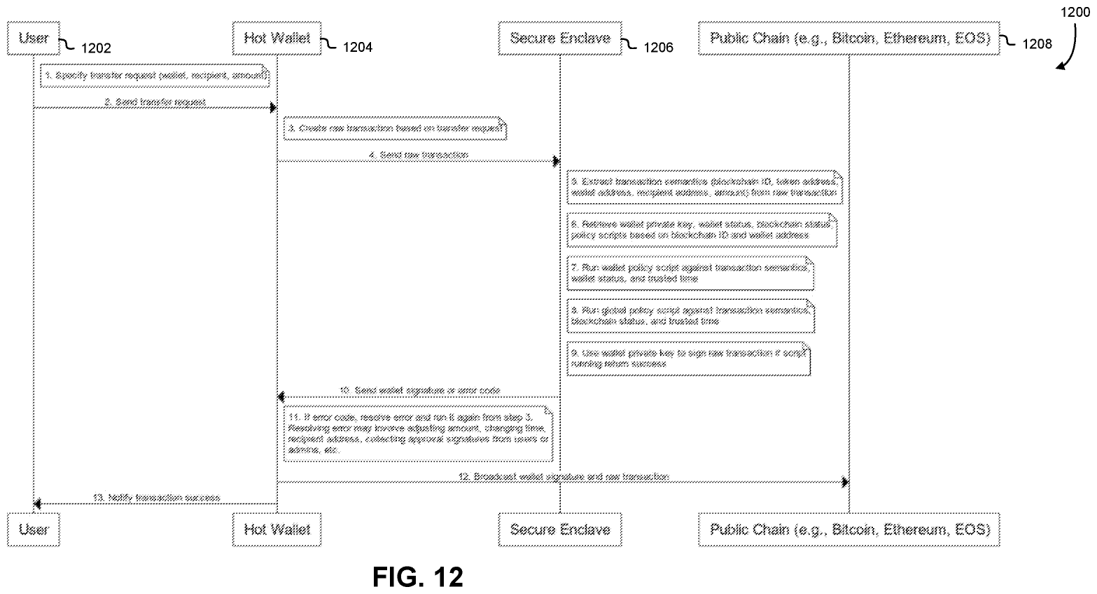

FIG. 12 illustrates a diagram 1200 illustrating secure hot wallet system based on secure enclave and programmable policy enforcement, in accordance with at least one embodiment. FIG. 12 illustrates, in at least one embodiment, a user 1202, hot wallet 1204, secure enclave 1206, and blockchain network 1208. User 1202 may refer to any suitable user that is able to submit transfer requests to a hot wallet 1204—for example, via a graphical user interface or command line interface of a computing device. A hot wallet may be a network-connected device that has access to the blockchain network 1208 illustrated in FIG. 12. The user may send a transfer request to the hot wallet that specifies various transfer request parameters which may include: wallet, recipient, amount, and more. For example, a transfer request may include one or more approver digital signatures which are verified by secure enclave 1206 as part of a validation process that is performed prior to generating digital signatures with a wallet private key stored within the context of a protected execution environment.

User 1202 may be a user of hot wallet 1204. User 1202 may be a computing entity configured to submit requests to the hot wallet 1204 to execute commands via an application programming interface (API). User 1202 may specify a request to execute a blockchain transaction. A non-limiting example of a request is a transfer request that sends an amount of digital assets (e.g., ETH, BTC) from hot wallet 1204 to another user (not shown in FIG. 12). The transfer request may be in the form of an API request that specifies wallet, recipient, and amount to transfer. User 1202 may send the request to hot wallet 1204 in any suitable manner, such as in the form of an API request described above. In at least some embodiments, the request is accompanied by a digital signature authenticating the user.

Hot wallet 1204 may refer to computer hardware, software, or a combination thereof that receives a request from user 1202 and create a raw blockchain transaction from the request. A request may include fields such as wallet address, recipient, and amount which are encoded as parameters of a raw blockchain transaction. A raw blockchain transaction, as noted above, may lack a digital signature signed by the hot wallet's private key, which is accessible from within secure enclave 1206 (e.g., not accessible to hot wallet 1204 or the portion thereof running outside of the protected execution environment). Hot wallet 1204 may send a raw blockchain transaction to the enclave 1206 as part of a signing process in which secure enclave 1206 uses a programmable policy to enforce conditions on what types of raw blockchain transactions are signed.

Secure enclave 1206 may be used to implement a protected execution environment using computer hardware, software, or a combination thereof. In at least one embodiment, a secure enclave 1206 is implemented according to techniques described in connection with FIG. 19. A hot wallet may submit a raw blockchain transaction to a secure enclave by invoking an enclave entry point API. Secure enclave 1206 may receive a raw blockchain transaction from hot wallet 1204 and extract transaction semantics. The transaction semantics may include some or all of the following information from the raw blockchain transaction: blockchain ID, token address, wallet address, recipient address, and amount. Secure enclave 1206 may retrieve wallet private key and security policies based on the blockchain ID and wallet address. For example, a key-value pair may be used to store and retrieve security policies using blockchain ID and wallet address pair as a key and security policy script for the wallet as a value. A wallet-specific security policy script may have a binding that associates it to a specific wallet, whereas a global security policy script may be applicable to all wallets within a blockchain network. In some cases, group policy scripts may be applicable to sets of wallets. In at least one embodiment, key-value pairs may be used to associate blockchain networks to global policy scripts.

A security policy script may refer to code (e.g., source code, object code, etc.) that can be executed (e.g., as a result of compiling or interpreting human-readable source code) by secure enclave 1206. Non-limiting examples of security policy scripts include wallet-specific security policy scripts that are associated with a specific blockchain identifier and wallet address; global security policy scripts that are associated with a specific blockchain network; and so on. Security policy scripts may be associated with specific blockchain networks and/or blockchain wallets through the use of admin commands, the execution of which may be authorized by a quorum of administrator digital signatures. In at least one embodiment, administrators collectively agree upon security policy scripts and update global and/or wallet state with the corresponding security policy scripts which are to be executed. Security policy scripts may be written in different programming languages such as JavaScript, Python, Solidify, and more. In at least some embodiments, security policy scripts conform to a particular format that has a defined set of inputs and outputs. For example, a wallet policy script may have a predefined format to accept transaction semantics, wallet status, and trusted time as inputs the script. As a second example, a global policy script may have a predefined format to accept transaction semantics, blockchain status, and trusted time. A policy script may generate, as an output, a binary value indicating whether the security policy encoded by the script has been violated. Trusted time may refer to time information that is trusted by the protected execution environment, at least in the sense that it can be proven or verified that the trusted time information as not modified by an operating system.

Enclave 1206 may retrieve wallet private key, wallet status, blockchain status, or any suitable combination thereof. Applicable security policy scripts may also be obtained, for example, by querying a key-value map using information included in the transaction semantics provided to the secure enclave. Blockchain identifier and wallet address information from transaction semantics may be used to obtain a wallet-specific security policy script. Blockchain identifier that resolves to a blockchain network may be used to obtain a global security policy script. In at least one embodiment, wallet policy script includes or can be used to determine executable code that can be run by secure enclave. In at least some embodiments, a wallet policy script is executed within the context of a protected execution environment against transaction semantics, wallet status, and trusted time to determine whether a secure enclave should use a wallet private key to sign a raw blockchain transaction. In at least some embodiments, a global policy script is executed within the context of a protected execution environment against transaction semantics, blockchain status, and trusted time to determine whether a secure enclave should use a wallet private key to sign a raw blockchain transaction.

If all applicable security policy scripts pass (e.g., all scripts run to completion and return success), secure enclave 1206 may use wallet private key to digitally sign the raw blockchain transaction. However, if an applicable security policy script fails, an error code may be returned. If a security policy script returns an error, secure enclave 1206 may resolve the error and run the policy script again. For example, one or more fields of the blockchain transaction may be modified, including any combination of amount, changing time, recipient address, and more. In at least one embodiment, running a security policy results in an error that indicates insufficient authorization has been presented to sign the raw blockchain transaction and, in response to such an error code, the secure enclave may either directly or indirectly obtain a quorum of approver signatures to authorize the signing of the raw blockchain transaction.

The secure enclave 1206 may send the wallet signature and the raw blockchain transaction to the hot wallet 1204. In some cases, the secure enclave provides only the wallet signature to the hot wallet 1204, such as in embodiments where the hot wallet retains a copy of the raw blockchain transaction which can be associated with the wallet signature it receives from the secure enclave 1206. In at least some embodiments, hot wallet 1204 broadcasts the wallet signature and raw blockchain transaction to blockchain network 1208. Noes of the blockchain network 1208 may use a public key associated with the hot wallet's blockchain address validate the wallet signature and raw blockchain transaction are valid, and process the raw blockchain transaction accordingly. For example, a balance of digital assets may be transferred from the hot wallet to another blockchain user as a result of processing the raw blockchain transaction. The hot wallet 1204 may notify the user 1202 of success or failure of the blockchain transaction based on whether the raw blockchain transaction was successfully broadcasted, processed, and/or confirmed to blockchain network 1208.

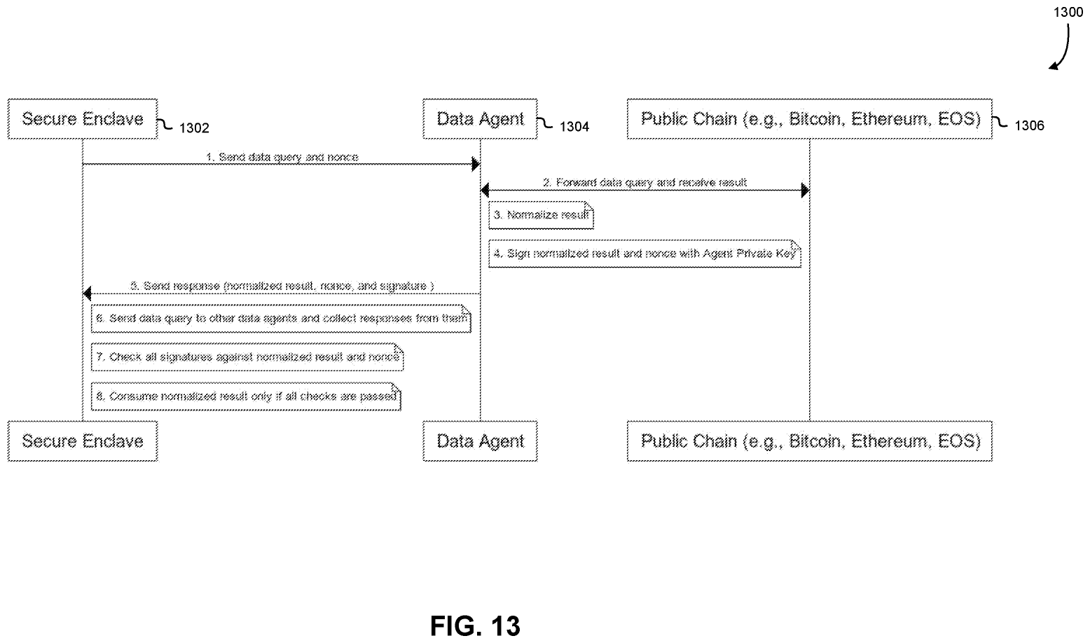

FIG. 13 illustrates a diagram 1300 illustrating loading trusted data from blockchain to secure enclave with multi-signature authorization, in accordance with at least one embodiment. FIG. 13 illustrates, in at least one embodiment, a secure enclave 1302, data agent 1304, and blockchain network 1306. Secure enclave 1302 may be implemented in accordance with techniques discussed elsewhere in this disclosure, such as those described in connection with FIG. 19. Data agent 1304 may be computer hardware, software, or a combination thereof. Data agent 1304 may be implemented as a computing device described in connection with FIG. 20 or as a component thereof (e.g., as hardware, software, or a combination of both). Blockchain network 1306 may be a public blockchain network such as Bitcoin, Ethereum, or EOS.

In at least one embodiment, secure enclave 1302 implements a protected execution environment and runs enclave code. In some cases, an application running within the context of a protected execution environment may request data from outside of the protected execution environment. However, an adversary or malicious party may attempt to tamper with external data requested by a protected execution environment. External data may include, for example, information that is stored on a public blockchain network. It may be the case that it is difficult or impossible to run a blockchain node within a secure enclave. Techniques described herein may be used to establish a trust in the validity of data external to a protected execution environment.

Secure enclave 1302 may submit a request for data to a data agent, wherein the request may include, be accompanied by, or otherwise be associated with a nonce. A nonce may refer to a number that is used only once, which can be used to prevent replay attacks. Data agent 1304 may include a program that runs outside the context of a protected execution environment. Data agent 1304 may receive a request from secure enclave 1302. The request may include or otherwise encode a data query which data agent 1304 forwards to blockchain network 1306. A request may, for example, be a request for various information that is publicly available on blockchain network 1306, such as chain state information, wallet balances, and more. In at least some embodiments, data agent 1304 receives a result from blockchain network 1306, normalizes the result. Data agent 1304 may generate a digital signature over a message that includes a result (e.g., normalized result) and the nonce that was provided to data agent 1304 by secure enclave 1302. The data agent 1304 may use an agent private key to sign the message, wherein the corresponding public key is available to the secure enclave 1302. A digital certificate may be used to prove ownership of a public key, such as those described herein. Data agent 1304 may send a response with a result, nonce, and digital signature to secure enclave 1302.

Secure enclave 1302 may obtain messages, nonces, and digital signatures from multiple data agents. For example, data agent 1304 illustrated in FIG. 13 may be one among several data agents which secure enclave 1302 submits requests to for the same data. Secure enclave 1302 may, accordingly, receive multiple signed messages—one from each data agent. In some embodiments, secure enclave 1302 sends the requests in parallel. In some embodiments, secure enclave 1302 sends the requests serially. In some embodiments, secure enclave 1302 sends the request in batches or in any other suitable manner for requesting and receiving multiple signed messages. Each signed message may include a message that is digitally signed with a different nonce and a data payload for the request.

Secure enclave 1302 may verify the validity of all signatures received against the results and nonce values. Secure enclave 1302 may verify that the same nonce that was sent to a data agent was received as part of that data agent's signed response. In at least one embodiment, secure enclave 1302 verifies that the data payload of all data agents matches and accepts the data payload as true only if all data agents agree upon the data payload, which may include values, strings, and more. Secure enclave 1302 may consume the result (data payload) only if all data agents provide the same result. In some cases, secure enclave 1302 consumes results based on a quorum of data agents providing the same result and discards results from other data agents that provide different results. In some cases, if a first data agent provides a different answer from that provided by a quorum of other data agents, it may indicate that first data agent may be compromised and no longer can be trusted—accordingly, the secure enclave may remove that first data agent from a list of data agents.

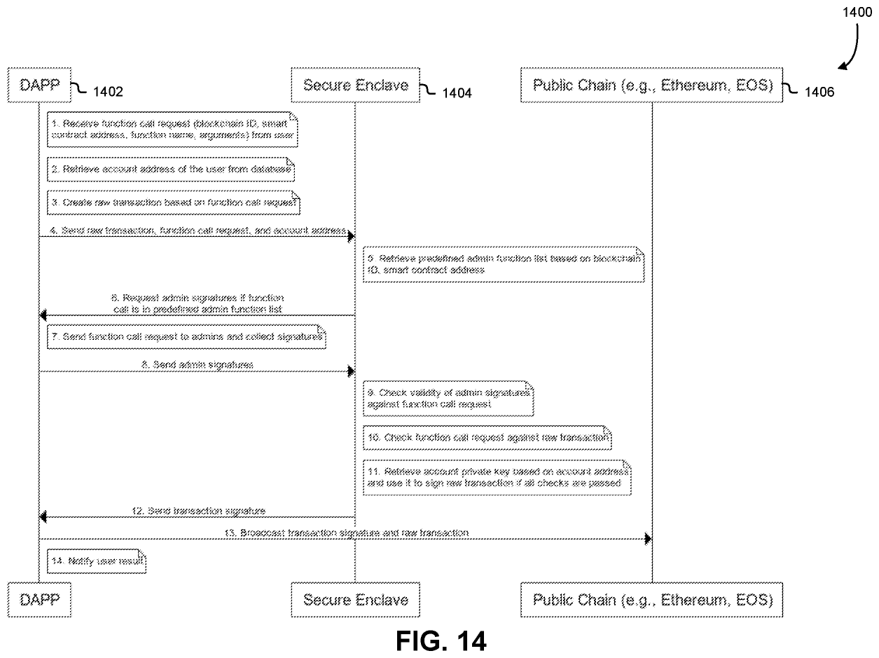

FIG. 14 illustrates a diagram 1400 illustrating secure smart contract with secure enclave and multi-signature authorization, in accordance with at least one embodiment. FIG. 14 illustrates, in at least one embodiment, a decentralized application 1402, secure enclave 1404, and blockchain network 1406. Secure enclave 1404 may be implemented in accordance with techniques discussed elsewhere in this disclosure, such as those described in connection with FIG. 19. Blockchain network 1406 may be a public blockchain network such as Ethereum, or EOS on which a decentralized application is built upon. In at least one embodiment, blockchain network 1406 is any suitable blockchain network that supports execution of smart contracts and/or decentralized applications.

Decentralized application 1402—alternatively referred to as DAPP or dApp—may refer to an application, script, smart contract, or other software that communicates with or otherwise interacts with a blockchain network which manages state information for all network actors. In at least one embodiment, a DAPP has frontend logic that is run locally (e.g., on a computing device in accordance with FIG. 20) and backend logic that is represented by one or more smart contracts interfacing with an underlying blockchain network.

In at least one embodiment, DAPP 1402 receives a function call request from a user that includes one or more parameters which may include any of the following: blockchain identifier, smart contract address, function name, arguments, and more. A user may submit the request to DAPP 1402 via a graphical user interface. DAPP 1402 may retrieve account address of the user from a database and create a raw blockchain transaction based on the function call request and send the raw blockchain transaction, function call request, and account address to secure enclave 1404.

Secure enclave may retrieve predefined admin function list based on blockchain identifier, smart contract address, and request admin signatures if the function call is included in the list of admin function calls. The request may surface to DAPP 1402 as an error code that indicates insufficient privileges were presented and/or that additional authorization should be provided for fulfillment of the request. DAPP 1402 may send function call requests to admins and collect a quorum of admin digital signatures. Admin signatures may be signed over a message that encodes various information related to the request, such as the particular function call being request, the requestor's identity, a nonce (e.g., to prevent replay attack) and more. Admin digital signatures may be approver digital signatures. DAPP 1402 may send one or more admin signatures to secure enclave 1404 and secure enclave 1404 may check validity of admin signatures against the function call request. Secure enclave 1404 may check function call request against raw blockchain transaction to ensure that they match (e.g., value of fields within raw blockchain transaction match corresponding parameters of the function call match), if all checks pass, retrieve account private key based on account address and use the account private key to sign the raw blockchain transaction.

Secure enclave 1404 may send the account signature and/or the raw blockchain transaction to the DAPP 1402. DAPP 1402 may broadcast the raw blockchain transaction along with the corresponding digital signature to blockchain network 1406 where it is validated, processed, and confirmed to the blockchain ledger. In at least one embodiment, DAPP 1402 notifies the user of success or failure of broadcasting the blockchain transaction.

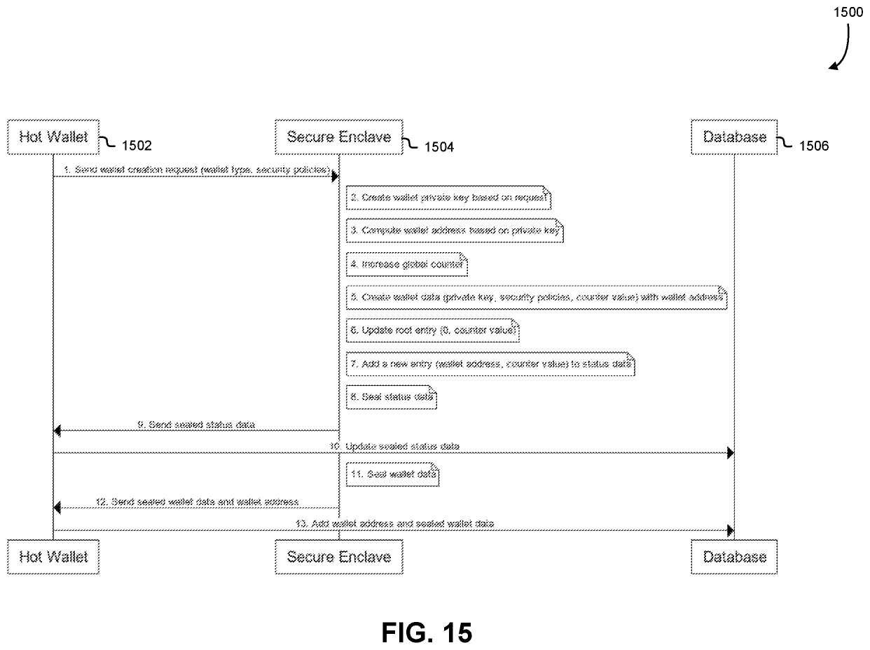

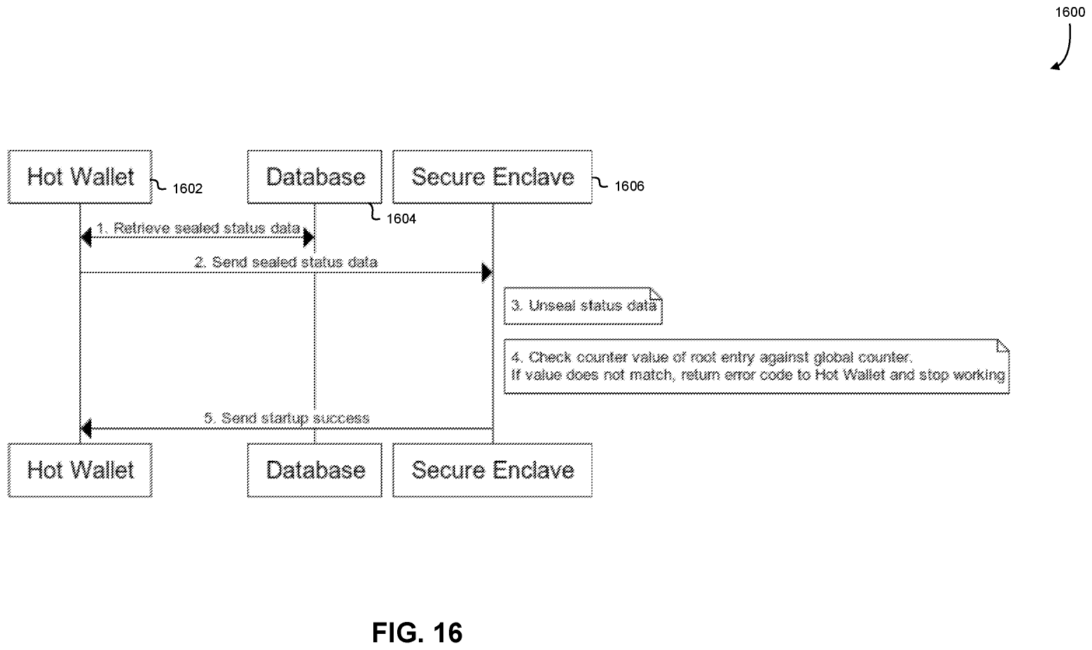

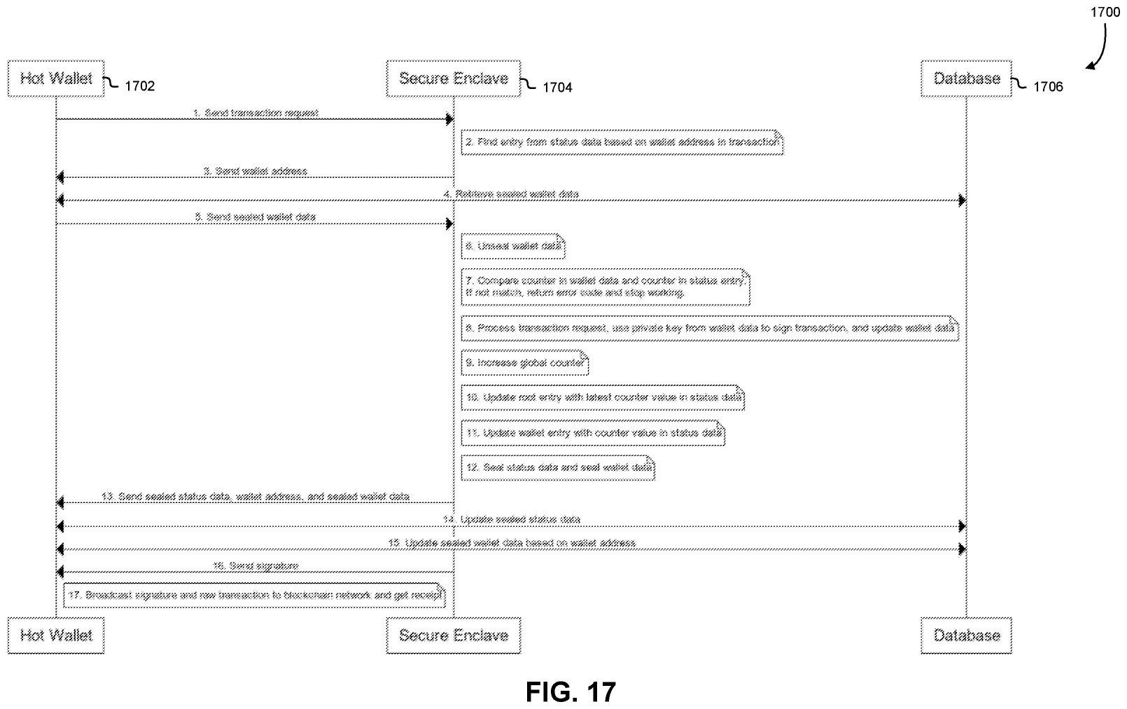

FIG. 15 illustrates a diagram 1500 illustrating at least one aspect of secure storage of wallet data and policies based on secure enclaves, in accordance with at least one embodiment. FIG. 15 illustrates, in at least one embodiment, a hot wallet 1502, secure enclave 1504, and database 1506. Hot wallet 1502 may be in accordance with those described elsewhere in this disclosure and may be implemented as and/or using a computing device in FIG. 20. Secure enclave 1504 may be implemented in accordance with techniques discussed elsewhere in this disclosure, such as those described in connection with FIG. 19. Database 1506 may refer to a structured data store. In some embodiments, any suitable data storage system may be used in place of database 1506, for example, a file system, hard disk drive, network storage device, distributed data store (e.g., IPFS), and more. In at least one embodiment, FIG. 15 illustrates a workflow for creating a blockchain wallet according to techniques for secure storage of wallet data and policies based on secure enclaves. Techniques described in connection with FIG. 15 may be implemented in conjunction with those discussed in connection with FIGS. 16 and 17.

Hot wallet 1502 may be any suitable network-connected blockchain wallet such as those described elsewhere in this disclosure (e.g., including those incorporated by reference). In at least one embodiment, hot wallet 1502 sends a request to secure enclave 1504 to create a wallet. A wallet creation request may include parameters such as wallet type and applicable security policies. Hot wallet 1502 may send a wallet creation request to enclave 1504 by invoking an enclave entry point API call which transitions execution of a program from an unprotected execution environment to a protected execution environment.

Secure enclave 1504 may receive a wallet creation request and perform steps to create a wallet. In at least one embodiment, secure enclave 1504 creates a wallet private key based on a wallet creation request, by using, for example, an entropy source to generate a random number. In at least one embodiment, a pseudo-random number generator is used to generate a wallet private key. In some embodiments, a corresponding wallet public key is derived from a wallet private key. In at least one embodiment, wallet address is computed from wallet private key.

Secure enclave 1504 may store (e.g., in enclave memory) a global counter that is used to track state related to one or more blockchain networks. A global counter may be a 32-bit integer, 64-bit integer, or larger counter that is monotonically incremented to track state related to one or more blockchain networks. For example, when a wallet is created, a global counter may be incremented. A global counter may be resident to a secure enclave and securely persisted such that it is not exposed outside of the protected execution environment in a plaintext format and retained across reboots or power outages. A global counter may be treated as enclave data that is to be kept secret from entities outside of the protected execution environment.

Secure enclave 1504 may create a blockchain wallet and associate a private key, security policy, and a counter value (e.g., global counter) with the wallet's blockchain address. The creation of a blockchain wallet may occur in conjunction with a global counter increment, which may occur before, after, or during the wallet creation. In some cases, wallet creation and global counter increment are an atomic operation which occurs in an all-or-nothing manner.

Secure enclave 1504 may update a root entry with an initial value of (0, counter value). The root entry may be used to track the current global counter value. The root entry may be the first entry of the status data, or be otherwise stored in a predefined location of a data structure of the status data. Wallet creation may involve updating status data, which may include a mapping that indicating the counter value associated with the most recent update to the state of each blockchain address (e.g., wallet or smart contract address). For example, when a blockchain wallet is created, a global counter value is associated with the blockchain wallet creation, and that global value may be written to a key-value map wherein keys are wallet addresses and values and their respective global counter values. Status data may be updated at subsequent global counter values after wallet create, such as when wallet state is modified at a later point in time.

Secure enclave 1504 may seal status data. Sealing data may refer to a process in which enclave data is encrypted using a cryptographic key and exported from a protected execution environment in a ciphertext format. Sealed data encrypted under a cryptographic key resident to an enclave may be persisted in a data storage system outside of a protected execution environment. Data may be sealed using a sealing key. A sealing key may be a cryptographic key (e.g., symmetric or asymmetric key) which is derived from an enclave master key. For example, enclave 1504 may create different sealing keys for sealing different data objects. In some cases, a sealing key is used to seal a data object and an enclave master key is used to encrypt the sealing key—the sealed data and the encrypted sealing key may be exported from the protected execution environment and stored as a pair. Hot wallet 1502 may receive sealed status data and store the sealed status data in database 1506. In some embodiments, hot wallet 1502 receives sealed status data from secure enclave 1504 and replaces a previous version of the sealed data (e.g., stored in same location in database, file system, etc.). Data may be sealed by secure enclave for various reasons. For example, data may be sealed as part of a shutdown process in which execution of a secure enclave is being terminated (e.g., shutdown of a computer system running the enclave). Enclave data may be sealed periodically or based on a notification or signal.

Secure enclave 1504 may seal wallet data, for example, using techniques described above. Secure enclave 1504 may provide sealed wallet data and/or wallet address to hot wallet 1502 in response to a request to create a blockchain wallet. Hot wallet 1502 may use the wallet address by, for example, distributing it to other entities, encoding as recipient address in raw blockchain transactions, and more. Hot wallet 1502 may add wallet address and sealed wallet data to database 1506.

FIG. 16 illustrates a diagram 1600 illustrating at least one aspect of secure storage of wallet data and policies based on secure enclaves, in accordance with at least one embodiment. FIG. 16 illustrates, in at least one embodiment, a hot wallet 1602, database 1604, and secure enclave 1606. Components described in FIG. 16 may be in accordance with those described elsewhere in this disclosure. In at least one embodiment, FIG. 16 illustrates a workflow for starting up a blockchain wallet according to techniques for secure storage of wallet data and policies based on secure enclaves. Techniques described in connection with FIG. 16 may be implemented in conjunction with those discussed in connection with FIGS. 15 and 17. In at least one embodiment. FIG. 16 illustrates a workflow which occurs after wallet creation, which may be implemented using techniques described in connection with FIG. 15.

Hot wallet 1602 may be a hot wallet associated with a wallet address that was created using techniques described in connection with FIG. 15. In at least some embodiments, hot wallet 1602 retrieves sealed status data from database 1604 and sends the sealed status data to secure enclave 1606. Secure enclave data 1606 may receive the sealed status data and perform one or more verification checks on the sealed status data. Because sealed status data was stored outside of the protected execution environment of the secure enclave, there may be concerns that the sealed status data was tampered with—for example, another party may have modified the ciphertext data or replaced it with an older copy that reflected valid status data at an earlier point in time which is no longer valid. Secure enclave 1606 may have access to a global counter value, which may be persisted across reboots in a protected execution environment.

Secure enclave 1606 may receive the sealed status data and decrypt it using a sealing key to obtain plaintext status data. Unsealing data may be performed based on how data was sealed—for example, if data was sealed using a symmetric sealing key, the symmetric sealing key may be used to decrypt sealed data to obtain the unsealed data. As a second example, if a sealing key is used to encrypt data to produce sealed data and enclave master key is used to encrypt the sealing key to produce an encrypted sealing key, secure enclave 1606 may receive the encrypted sealing key along with the sealed data. Continuing with the example, the enclave master key may be used to decrypt the encrypted sealing key to obtain a plaintext version of the sealing key which can, in turn, be used to decrypt the sealed data to obtain unsealed data (e.g., unsealed status data). Secure enclave 1606 may compare the counter value of root entry of the status data against the current global counter value. If root entry value of the unsealed status data matches the current global counter value, the status data may be accepted. However, if the root entry value was a previous number, the sealed status data provided by hot wallet 1602 may be rejected. An error code may be returned to indicate that the sealed status data is invalid, and the secure enclave may stop working. If the counter value of the root entry of the unsealed status data matches the current global counter value, then the startup (or at least a portion thereof) may succeed such that the status data is accepted and secure enclave 1606 returns a success code to hot wallet 1602.

FIG. 17 illustrates a diagram 1700 illustrating at least one aspect of secure storage of wallet data and policies based on secure enclaves, in accordance with at least one embodiment. FIG. 17 illustrates, in at least one embodiment, a hot wallet 1702, secure enclave 1704, and database 1706. Components described in FIG. 17 may be in accordance with those described elsewhere in this disclosure. In at least one embodiment, FIG. 17 illustrates a workflow for using a sealed blockchain wallet according to techniques for secure storage of wallet data and policies based on secure enclaves. Techniques described in connection with FIG. 17 may be implemented in conjunction with those discussed in connection with FIGS. 15 and 16. In at least one embodiment. FIG. 17 illustrates a workflow which occurs after wallet creation, which may be implemented using techniques described in connection with FIG. 15, and wallet startup, which may be implemented using techniques described in connection with FIG. 16.

Hot wallet 1702 may send a blockchain transaction request to secure enclave 1704. In at least one embodiment, blockchain transaction request is a request to sign a raw blockchain transaction. Secure enclave 1704 may use status data to lookup an entry associated with the blockchain address of hot wallet 1702. Status data may be unsealed and validated using techniques described in connection with FIG. 16 as part of a startup process prior to the secure enclave receiving the blockchain transaction request illustrated in FIG. 17. In at least some embodiments, secure enclave 1704 examines the received blockchain transaction request to determine a wallet address and corresponding wallet private key to generate digital signatures with. In at least some embodiments, secure enclave 1704 checks whether wallet data for the wallet address has been loaded in enclave memory. In at least some embodiments, if the wallet data has not been loaded to enclave memory, secure enclave 1704 may send a message or status code to hot wallet 1702 to provide the wallet data. In some embodiments, secure enclave 1704 sends the wallet address to hot wallet 1702.

Hot wallet 1702 may retrieve sealed wallet data from database 1706. In some embodiments, hot wallet 1702 uses wallet address to determine a location in a file system or data storage system (e.g., data storage service of a computing resource service provider) to obtain the sealed wallet data. In some embodiments, the wallet address is used to construct a database query to obtain the sealed wallet data from a database. Hot wallet 1702 may retrieve the sealed wallet data and send it to secure enclave 1704. Secure enclave 1704 may receive the unsealed wallet data and unseal it by decrypting the sealed wallet data using an enclave master key.

The unsealed wallet data may include a counter value. Enclave 1704 may compare the counter value from the unsealed wallet data with a corresponding counter value in status data. Status data may be obtained according to techniques described in connection with FIG. 16. Status data may include a key-value mapping that associates a wallet address (key) to a counter value (value). If the counter value in the status data and the counter value in the unsealed wallet data match, the unsealed wallet data may be accepted as valid. However, if the counter value associated with the wallet address in the status data does not match the counter value of the unsealed wallet data, the unsealed wallet data may be rejected as being invalid—for example, it may be an older version of wallet data from a previous point in time.

Secure enclave 1704 may determine the wallet data is valid and, as a result, process the hot wallet's blockchain transaction request, for example, by using a private key from the wallet data to sign the transaction, and update wallet data (e.g., wallet balance). Secure enclave may, as part of processing the blockchain transaction request, increment a global counter. A root entry of the status data may be updated with the updated global counter value. The wallet data may be updated with the updated counter value. In some cases, the processing of the blockchain transaction, the incrementing of the global counter, the updating of the status data and/or the wallet data (or a combination thereof) may be performed as an atomic operation.

In some cases, wallet data is loaded and used by secure enclave 1704 to fulfill other requests, signing raw blockchain transactions, and more. In some cases, secure enclave 1704 may determine to unload wallet data and/or status data from the secure enclave 1704. For example, a secure enclave may have a finite amount of enclave memory and may unload wallet data for a first blockchain address in order to load wallet data for a second blockchain address. As a second example, a secure enclave may unload wallet data and status data as part of a shutdown sequence.

Secure enclave 1704 may seal wallet data and/or status data by encrypting such data using an enclave master key to generate sealed data. Secure enclave 1704 may send sealed wallet data, a corresponding wallet address, and sealed status data to hot wallet 1702. Hot wallet 1702 may store the updated sealed wallet data and/or updated status data in database 1706, for example, by overwriting previous versions of such sealed data.

Secure enclave 1704 may send a digital signature for a raw blockchain transaction requested by hot wallet 1702, and hot wallet 1702 may broadcast the raw blockchain transaction and digital signature to a blockchain network and the blockchain network may process, validate, and confirm the raw blockchain transaction to, for example, transfer an amount of digital assets from the hot wallet 1702 to another blockchain wallet.

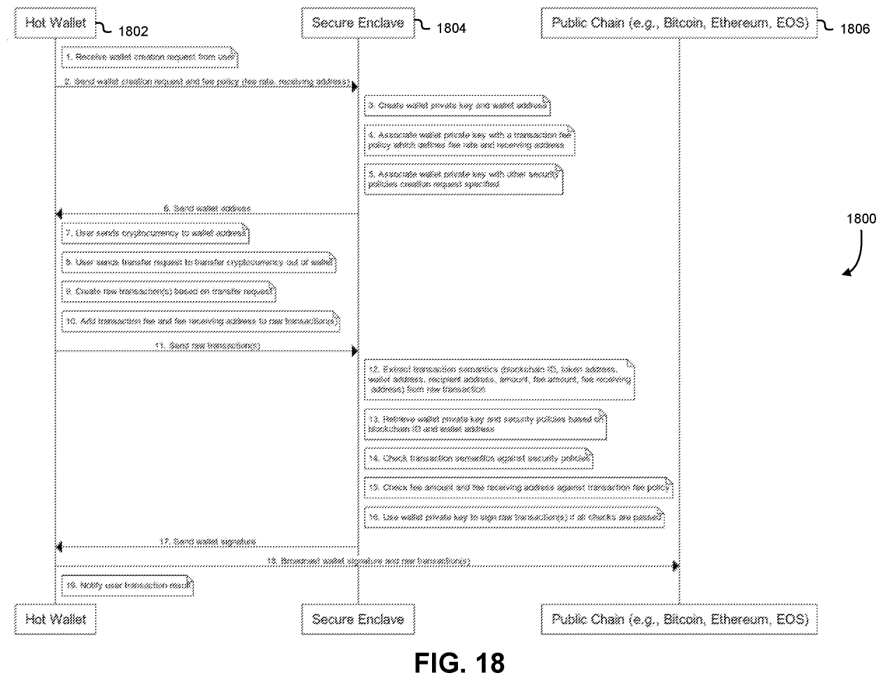

FIG. 18 illustrates a diagram 1800 illustrating secure blockchain transaction fee charging with secure enclave, in accordance with at least one embodiment. FIG. 18 illustrates, in at least one embodiment, a hot wallet 1802, secure enclave 1804, and blockchain network 1806. Hot wallet 1802 may be in accordance with those described elsewhere in this disclosure and may be implemented as and/or using a computing device in FIG. 20. Secure enclave 1804 may be implemented in accordance with techniques discussed elsewhere in this disclosure, such as those described in connection with FIG. 19. Blockchain network 1806 may refer to any suitable blockchain network, such as a public chain (e.g., Bitcoin, Ethereum, EOS). FIG. 18 may be implemented in the context of a cryptocurrency exchange, wherein users deposit digital assets to the exchange (e.g., an on-chain blockchain transaction) and then can perform various off-chain exchanges, such as swapping digital assets of one type to another type supported by the exchange (e.g., BTC to ETH). A user may, at any point, choose to withdraw funds, at which point the exchange may facilitate an on-chain transfer of digital assets to the user.

Hot wallet 1802 may receive a creation request from a user. A user may be any suitable type of user and may interface with hot wallet 1802 via a graphical user interface or command line interface, among other examples. Hot wallet 1802 may send a wallet creation request and fee policy to secure enclave 1804. A fee policy may include a fee rate and receiving address. The receiving address may be a blockchain wallet controlled by the user, wherein the user has access to the receiving wallet's private key. A wallet creation request may include other parameters not illustrated in FIG. 18, such as security policies, security policy scripts, and more.

Secure enclave 1804 may receive the wallet creation request and create a new blockchain wallet using techniques described herein. For example, secure enclave 1804 may create a wallet private key and wallet address and associate the wallet private key with a transaction fee policy which defines a fee rate and receiving address. The transaction fee policy may be implemented as a table in wherein different receiving addresses can have different fee rates. In some cases, a default rate may exist wherein if a particular address is not explicitly listed in the table, the default rate is used. Secure enclave 1804 may associate wallet private key with any applicable security policies specified by the wallet creation request.

Secure enclave 1804 may send the wallet address associated with the wallet private key to hot wallet 1802. Hot wallet 1802 may receive the wallet address and present that information to the user, which may be done using a graphical user interface (e.g., displayed on a screen or monitor) or as text. The user may take the wallet address and submit a request to transfer an amount of digital assets to the wallet address. Transferring digital assets from the user to the hot wallet may involve the user generating a digital signature using a private key.

In at least some embodiments, a user sends a transfer request at a later point in time to transfer digital assets out of hot wallet 1802. Hot wallet 1802 may create a raw blockchain transaction based on the request, which may include a user wallet address, an amount of digital assets to transfer from hot wallet 1802 to the user wallet, etc. Hot wallet 1802 may additionally add a transaction fee and a receiving address for the fee to the raw blockchain transaction. Hot wallet 1802 may provide the raw blockchain transaction (with both a transfer amount and fee amount) to enclave 1804.

Secure enclave 1804 may receive a raw blockchain transaction from hot wallet 1802 and extract transaction semantics from the raw blockchain transaction. Transaction semantics may include blockchain identifier, token address, wallet address, recipient address, recipient transfer amount, fee amount, fee receiving address, and any suitable combination thereof. Secure enclave 1804 may retrieve wallet private key and security policies based on blockchain identifier and/or wallet address. Security policies (e.g., security policy scripts) may be wallet-specific, chain-specific, etc. Secure enclave 1804 may check transaction semantics against security policies which may place restrictions on various aspects of the transaction semantics. For example, if transfer amount exceeds a predefined limit, a reviewer or manager signature may be required to sign the transaction. As a second example, a whitelist or blacklist policy may be applied on the recipient address that limits the domain of acceptable recipient addresses.

In at least some embodiments, secure enclave 1804 checks fee amount and fee receiving address against transaction fee policy and, if all checks are passed, uses wallet private key to sign the raw blockchain transaction. Secure enclave 1804 may provide the wallet signature to hot wallet 1802, and hot wallet 1802 may broadcast the wallet signature and raw blockchain transaction to blockchain network 1806. Blockchain network 1806 may validate, process, and confirm the raw blockchain to the ledger (e.g., based on a valid wallet signature). In at least some embodiments, hot wallet 1802 notifies user of the transaction broadcast result.

FIG. 19 illustrates an aspect of an environment 1900 in which various embodiments of the present disclosure may be practiced. As illustrated in FIG. 19, the environment 1900 may include a computer system 1902 comprising one or more processors 1904, memory 1906, application data 1908 and application code 1910, and an enclave 1912 supporting enclave data 1914 and enclave code 1916. The processor 1904 may support enclave functionality, such as support for Intel® Software Guard eXtensions (SGX), a module such as a trusted platform module (TPM), system microcode or combinations of these and/or other supported capabilities, for instantiating an enclave 1912. The enclave 1912 may be implemented in the context of a computer system with an input/output module that can be used to communicate with entities external to the computer system via a virtual or physical network.

In at least some embodiment, a protected execution environment can be executed within the context of a security module such as a hardware security module (HSM). An HSM may refer to a physical computing device that safeguards cryptographic keys by storing them within a tamper-resistant physical device. HSMs provide cryptographic key generation and storage, and perform cryptographic operations for authorized clients of the HSM. In some embodiments, a HSM includes a processor to execute code wholly within the context of the HSM to implement a protected execution environment. In at least some embodiments, cryptographic keys that are stored in a HSM are not exposed in a plaintext format outside of the HSM.

An enclave 1912—also referred to as a secure enclave—is a protected area in memory address space of a computer system that provides confidentiality and integrity for applications and data within the protected area, in accordance with at least one embodiment. An enclave 1912 can be used to operate as a protected execution environment—that is, the enclave prevents applications external to the enclave, even privileged applications such as virtualization monitors, basic input/output systems, operating systems, external processes running at high privilege levels, and even other enclaves, from accessing the enclave memory address space, but applications executing within the enclave may access executable instructions and data internal to the enclave. An enclave may provide cryptographically verifiable assurance of confidentiality for data and/or executable code used in the context of the enclave's protected execution environment. An enclave 1912 may prevent access to unencrypted enclave data (i.e., data resident within the enclave) by applications external to the enclave, and when the data is written to the memory address space, the data is automatically encrypted.

In various embodiments, a computer program execute application code 1910 or a portion thereof outside the context of an enclave 1912. A process, as part of executing the application code 1910, may access application data 1908 stored in various types of volatile memory such as registers, caches, and main memory (e.g., DRAM). The application code 1910 may, at a point in execution, include an entry point to the enclave 1912—for example, to perform an operation using private data that is not to be exposed outside the context of the enclave 1912, even to privileged system code such as a hypervisor or operating system. The entry point may be a function call that transitions execution of a computer program from the application code 1910 to enclave code 1916 in a protected execution environment. When execution is transitioned to the protected execution environment, the enclave 1912 has access to enclave data 1914, enclave code 1916, etc. Enclave code 1916 may be executed and the processor executing the code may have access to the enclave data 1914 as well as application data 1908 in a non-secure region of memory. Upon completion of at least a portion of enclave code, data (e.g., result(s) of execution of the enclave code) may be passed back to the application code 1910 which may resume execution in the non-secured region. Information exiting the enclave 1912 may be cleansed of data referring to the enclave's protected memory addresses to prevent external software from determining the location of enclave-protected data in memory.

In at least some embodiments, entry points to the enclave 1912 are pre-defined—for example, at compile time. An enclave entry point may be a trusted function that transitions execution of a computer program from a non-secured computing environment outside the context of an enclave 1912 to a protected execution environment within the enclave 1912. As an example, Intel® SGX supports enclave calls (ECALLs) as a type of pre-defined function which can be used to pass data and/or parameters to the enclave. Enclave code 1914 and/or enclave code 1916 may be stored in a specific region of trusted memory that is encrypted. In some embodiments, enclave data and enclave code is stored in an enclave page cache (EPC), encrypted under a cryptographic key generated by a physical processor on boot. Memory pages stored in the EPC may be decrypted only within a physical processor core.

Enclave functionality may be provided to a system through software, such as under the control of a hypervisor or a kernel of an operating system that allows virtualized user space instances, or through hardware by a specialized instruction set, such as Intel® Software Guard eXtensions (SGX), a module such as a trusted platform module (TPM), system microcode or combinations of these. Enclave functionality allows programmatic instantiation of an enclave, which may comprise initializing of an enclave control structure, allocating enclave memory, loading of enclave contents (e.g., applications and/or data loaded into the enclave) into the enclave memory, measuring of the enclave contents, and establishing an enclave identity. Enclave functionality may also include the ability to protect applications and/or data within the enclave from malicious software attacks, by detecting integrity violations of protected applications and/or data and preventing access to protected applications and/or data that fail integrity checks. It should be noted that an “application” as described herein may refer, based on the context of the description, to a computer program that both a non-secured portion running outside the context of an enclave, a secured portion that runs within the context of an enclave, or a combination of the two.

A characteristic of an enclave is an ability to provide remote attestation as to the state of the enclave. For example, the enclave may have a set of functions that, when executed by a processor, provide a measurement indicating the current state of executable code and/or data within the enclave. Another characteristic of an enclave is that it has a root of trust separate and protected from outside entities. That is, the enclave may have cryptographic keys resident within the enclave for digitally signing data output from the enclave, and, by verifying the digital signature, applications external to the enclave may be configured to trust the output data. Cryptographic keys resident within the enclave—such as private signing keys for a hot wallet—may be inaccessible to applications and systems external to the enclave.

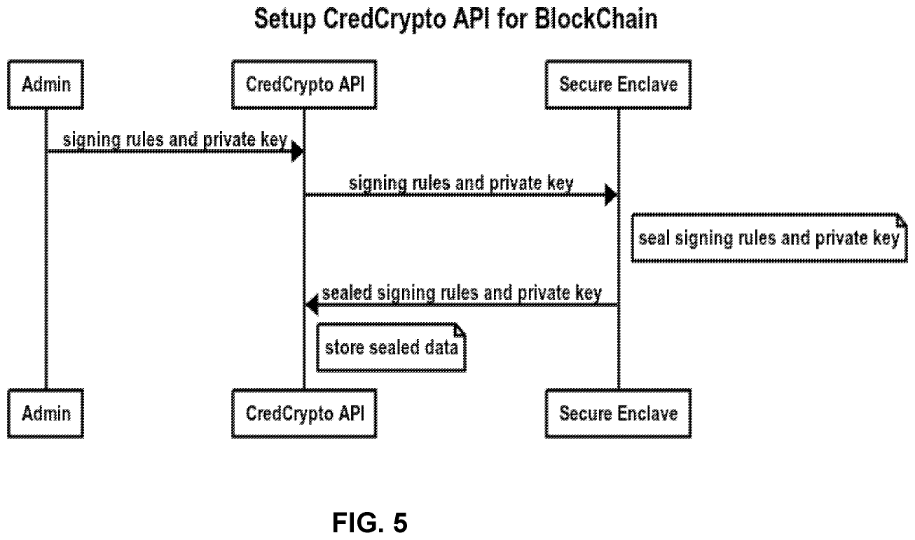

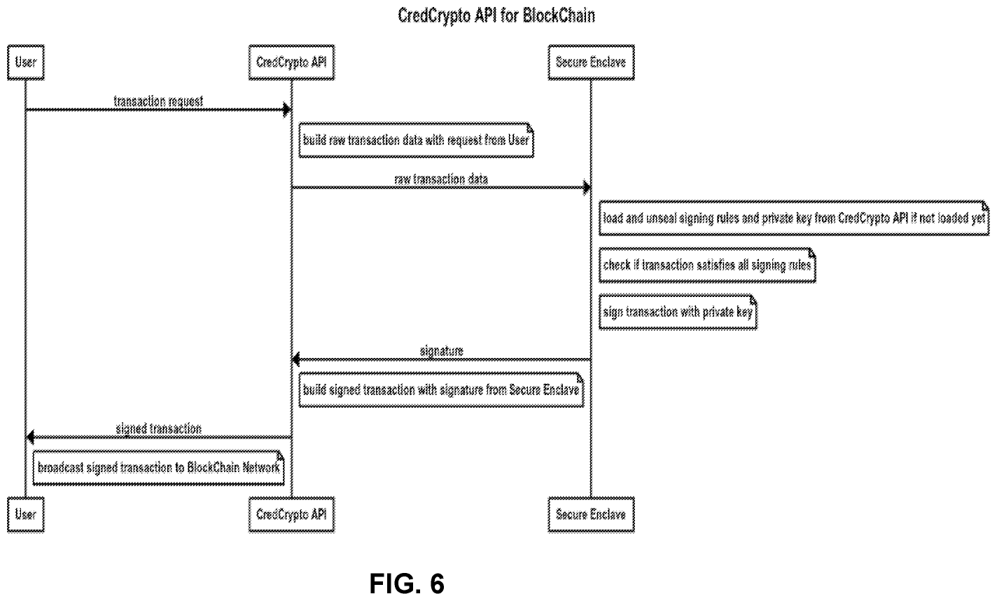

Enclave code may include, for example, computer-readable executable instructions that, as a result of execution by one or more processors, performs at least a portion of a process, such as any processes in accordance with those described in connection with FIGS. 1-6 and FIGS. 8-18.

The processor 1904 may include any suitable processing device capable of supporting enclaves, including processing devices based on Intel® Software Guard eXtensions. The memory 1906 may include a number of types of memory, such as described below in connection with FIG. 20.

Application data 1908 may include data structures, memory structures, and various other types of data that may be utilized in the course of the execution of application code 1910. Application code may include, for example, computer-readable executable instructions that, as a result of execution by one or more processors, performs at least a portion of a process, such as any processes in accordance with those described in connection with FIGS. 1-6 and FIGS. 8-18. For example, application code may be configured to execute portions of processes described in connection with FIGS. 1-6 and FIGS. 8-18 that are outside of the enclave. In general, an application may have instructions in the form of application code and data that is utilized in the execution of the instructions in the form of application data. In some cases, an enclave 1912 stores enclave data and/or enclave code within a protected execution environment so that the enclave data is not available to processes outside of the protected execution environment. As noted, the enclave 1912 may be a protected execution environment provided by supporting hardware or software on the computer system such as by a specialized instruction set, such as Intel® Software Guard eXtensions (SGX), a module such as a trusted platform module (TPM), system microcode, a hypervisor configured to manage a virtualization of protected execution environments or combinations of these and/or other supported capabilities. In this manner, a protected execution environment (e.g., an enclave) may be configured such that enclave data within the protected execution environment is protected from entities outside the protected execution environment.

Application code 1910 may include computer executable instructions that may be executed on a computer system, including an operating system, system and hardware drivers, business applications, entertainment applications, web browsers, e-mail clients, and anti-virus and other anti-malware applications. In some embodiments, such as that depicted in FIG. 19, enclave code runs one or more routines that may be instantiated within the enclave 1912 on the computer system. As noted, the enclave 1912 may be a protected execution environment provided by supporting hardware or software on the computer system such as by a specialized instruction set, such as Intel® Software Guard eXtensions (SGX), a module such as a trusted platform module (TPM), system microcode, a hypervisor configured to manage a virtualization of protected execution environments or combinations of these and/or other supported capabilities. One characteristic of a protected execution environment is the ability to provide remote attestation as to the state of the protected execution environment. For example, the protected execution environment may have a set of functions that, when executed by a processor, may provide a measurement indicating the current state of executable code and/or data within the enclave. Another characteristic of a protected execution environment is that it has a root of trust separate and protected from outside entities. That is an entity (e.g., an application running on a device operated by a user), may be configured to trust the protected execution environment because the protected execution environment may have cryptographic keys, such as a private key of a public-private key pair, not visible to outside entities, and outside entities can verify (e.g., trust) information coming from the protected execution environment because the information may be verified as digitally signed with the private key of the enclave. In this manner, a protected execution environment (e.g., an enclave) may be configured such that enclave code within the protected execution environment is protected from entities outside the protected execution environment.

The enclave 1912 may be provided by selecting computer systems being configured to support the instantiation of enclaves and causing the enclave 1912 to be instantiated. The computer systems may support the instantiation of enclaves based on the hardware capabilities of the system. For example, enclave functionality may be provided to a system by a specialized instruction set, such as Intel® Software Guard eXtensions, a module such as a trusted platform module, system microcode or combinations of these and/or other supported capabilities. As an example, the enclave 1912 may be provided by selecting a computer system, such as from a web-based management console, from computer systems configured to support enclave functionality.

Enclave functionality may include functionality for creating, deprovisioning, measuring (i.e., gathering metrics from), and populating enclaves. Enclave functionality may further include generating keys and/or sending and receiving data. Access to such enclave functionality may be provided by a code library, an interface, web service, application programming interface (API), or other access methodology. In response to receiving a request through one of the methods of accessing enclave functionality, a computing resource service provider may provide that access to a user of a computer system. Note that the providers of enclave functionality, the types of enclave functionality, and the methods of providing access to enclave functionality described are for illustrative purposes and, as such, other providers of enclave functionality, types of enclave functionality and methods of providing access to enclave functionality as would be contemplated by a person having ordinary skill in the art may be considered as within the scope of the present disclosure.

In some embodiments, upon instantiation or upon request, instructions executed within the enclave 1912 by a processor may generate a set of cryptographic keys for encrypting, decrypting, and performing integrity validation of data passing between the enclave 1912 and another entity. In some cases, the set of cryptographic keys may be a key-pair based on an asymmetrical public-private cryptographic scheme, and instructions executed within the enclave 1912 by a processor may provide the public key of the key-pair to a trusted entity and retain the private key of the key-pair securely within the enclave 1912 where it may not be accessible to outside entities. Subsequently, the trusted entity may encrypt data and/or instructions using the public key and provide the encrypted data and/or instructions to the enclave 1912, whereupon instructions executed within the enclave 1912 by a processor may decrypt the data and/or instructions using the private key held within the enclave 1912. Alternately or additionally, instructions executed within the enclave 1912 by a processor may digitally sign results of processing or execution using the private key within the enclave 1912 to provide assurance to the trusted entity that the output has not been tampered with or forged.

In other embodiments usable in combination with other embodiments, the trusted entity may generate a set of cryptographic keys for encrypting, decrypting, and performing integrity validation of data passing between the enclave 1912 and another entity. In some cases, the set of cryptographic keys may be a key-pair based on an asymmetrical public-private cryptographic scheme, and the trusted entity may provide the public key of the key-pair to the enclave 1912 and retain the private key of the key pair. Subsequently, instructions executed within the enclave 1912 by a processor may encrypt data and/or results of processing or execution using the public key before providing the data and/or results to the trusted entity, whereupon the trusted entity may decrypt the encrypted data and/or results using its private key. Alternately or additionally, the trusted entity may digitally sign data and/or instructions provided to the enclave 1912 using the private key of the trusted entity to provide assurance to the enclave 1912 that the data and/or instructions have not been tampered with or forged. Alternately or additionally, in a technique referred to as enveloping, instructions executed within the enclave 1912 by a processor may provide the trusted entity with a session key encrypted using the public key of the trusted entity. Subsequently, instructions executed within the enclave 1912 by a processor may provide encrypted data and/or results of processing of execution, whereupon the trusted entity may decrypt the encrypted data and/or results using the session key.

A computer system for hosting enclaves may be a distributed system with multiple hosts, may be a single system with virtual machine instances or may be a networked combination of such systems. A computer system may provide access to such as users, customers, modules, applications, services, processes, programs, operating systems, and controlling domains. Some of the access provided by the computer system to these entities may include providing access to confidential data and/or privileged applications. A computer system may also provide data storage regions to the customer, including memory, disk storage, virtual memory and virtual disk storage. Consequentially, some of the data storage regions provided by the computer system may be configured to store confidential and/or otherwise significant data.

A computer system for hosting enclaves may also run entities (e.g., applications, processes, services, modules, etc.) configured to access and/or manipulate such confidential data. A computer system may also run applications from a computing resource service provider that may utilize privileged code or perform operations on confidential data. Additionally, a computer system may include operating systems, privileged users, and controlling domains having full access to the computer system resources, such as direct access to the computer memory 1906, processors, data storage, and the network. A customer may wish to secure confidential data, and any applications configured to access such confidential data, by preventing access to the data and/or applications by entities without proper credentials, even those entities that are typically trusted entities such as operating systems, privileged users, and controlling domains. Similarly, a computing resource service provider may be configured to secure such confidential data and any applications configured to access the confidential data by preventing access to the confidential data and applications by any entity without proper credentials.

An entity, such as a service or operating system running on the computer system, the controlling domain, a guest domain running a virtual machine instance, or a service or operating system of the controlling domain or a guest domain, may provide an interface to enclave functionality. An entity (e.g., a user operating a device running applications) with access to a virtual machine instance on the computer system may use that interface to the enclave functionality to, for example, create an enclave, populate the enclave, and/or obtain keys.

In an illustrative example, a computer system may provide enclave functionality, as noted, via the SGX instruction set that may be enabled on the CPU of the computer system, although the scope of the present disclosure extends to other enclaves. The physical hardware of the computer system may be any device or equipment configured to execute instructions for performing data computation, manipulation or storage tasks, such as a computer or server. The computer system may be equipped with processors 1904, including a CPU, a graphics processing unit (GPU), and a digital signal processor (DSP). The computer system may further include memory 1906, including static and dynamic volatile memory, and non-volatile persistent storage such as optical and magnetic storage disks, tape, and flash memory. The computer system may also include additional hardware such as buses, input/output modules, and networking equipment compliant with any handshaking, communications or data transfer protocol.

As noted, a host computer system may provide enclave functionality through instructions made to the processors 1904 configured to support a protected execution environment, such as SGX, TPM or a hypervisor configured to support management of protected execution environments. The enclave functionality may be provided to various other services running on the host computer system. For example, a virtual computer system service of a computing resource service provider running on the host computer system may provide enclave functionality to a virtual machine instance running under the control of the virtual computer system service. Similarly, other services, such as block-level data storage services, cryptography services, on-demand data storage services, archival storage services, notification services, authentication services, policy management services, billing services and task services, may also access the enclave functionality to provide that functionality to resources associated with those services. Enclave functionality may also be provided to customers of the computing resource service provider. For example, an entity with access to a service and/or access to the resources served by that service may use enclave functionality to further secure data and/or applications associated with that service. In an illustrative example, a virtual computer system service and/or a virtual machine instance associated with that virtual computer system service may use the enclave functionality to create an enclave, populate the enclave with data and/or applications, obtain keys for decrypting results from the enclave, start the applications within the enclave and receive updates.

The measurements may indicate a current state of the enclave 1912 and/or contents within the enclave 1912. The measurements may be evaluated within the enclave 1912 or may be sent outside the enclave 1912. Enclaves may be configured such that measurements are performed entirely within a secure portion of the processors 1904 and may also be configured so that the measurements are signed by secret materials provided by the processors 1904, such as, for example, microcode running on the processors 1904 or a private key. In this way, measurements may be verified as correct by trusted users using the functionality provided with the enclave. Measurements may be verified by, for example, an application programming interface, which may provide information usable to determine the state of the processors 1904.

The measurements may be based on measurements obtained from host computer system hardware, such as, for example, measurements obtained by utilizing SGX instructions supported by the processors 1904 of the host computer system. In order to obtain the measurement, the enclave 1912 may first need to be paused or frozen by halting the execution of applications running within the enclave 1912 and/or by placing the applications in a certain determined state. By pausing and/or freezing the applications and/or placing the applications in a determined state, external verification that the enclave 1912 and its contents have not been tampered with may be made by comparing the measurements with predicted values. Measurements may include, in some embodiments, verification and/or validation that the measurements were performed by a trusted, verified and/or validated source. For example, measurements performed by the processors 1904 executing the appropriate SGX instructions may be digitally signed by the processors 1904 and thereby verified as coming from the particular processors 1904. Likewise, measurements coming from a TPM may include a similar verifiable signature with the measurements as an assurance that the measurements were performed by the TPM and/or a process running thereon.

Application code and/or data installed in the enclave 1912 may include applications to provide access to and/or process other types of confidential data. For example, a payment processing application running as a web service on a host computer of a computing resource service provider may be executed in the enclave 1912 by first measuring the application, encrypting the application, injecting the application into the enclave 1912, and finally decrypting and running the application within the enclave 1912. Note that the methods of providing access to enclave functionality described are for illustrative purposes and, as such, other methods of providing access to enclave functionality as would be contemplated by a person having ordinary skill in the art may be considered as within the scope of the present disclosure.

In some embodiments, the enclave functionality may be provided as an application, process or module, and may, in some cases, be implemented as a single instance on a computer system providing enclave functionality for virtual machine instances. The application, process or module so configured may also operate on a remote machine and/or may provide enclave functionality in a distributed and/or hierarchical manner. Said application, process or module may further be configured to start automatically when a machine and/or virtual machine is started, or, alternately, may be started as needed (e.g., when a client entity requests access to the enclave functionality).

In at least one embodiment, enclave 1912 is used to control the data flowing into or out of a computer system and/or perform authorization logic for a customer of a computing resource service provider without confidential data, such as unencrypted passwords or decryption keys, being made available to the computing resource service provider. Entities outside of the enclave 1912, including the operating system, other applications and/or users, may not access the data stored in the enclave 1912. In some embodiments, data and application code may be provided to the enclave 1912 in encrypted form. In some embodiments, data and/or results of the processing of applications may be output from the enclave 1912 in encrypted form. The enclave 1912 may receive stored data, for example, from a computer system, process the data according to a particular request from an entity, such as a user, customer, service or application, utilizing executable instructions running within the enclave 1912. The stored data may be received in encrypted form, and the processing may include decrypting the stored data using a decryption key held within the enclave 1912. Instructions executed within the enclave 1912 by a processor may determine whether to provide the data or a subset of the data to the requestor and, based on the determination, may or may not transform the data into another form before providing the data to the requestor. The transformation of the data may entail encrypting the data with the same key as it may have been encrypted with before the enclave 1912 received it, encrypting or re-encrypting with a different key, and/or some other transformation of the data, such as censored (e.g., redacted) portions of the data.

In at least one embodiment, a customer provides an enclave 1912 with data to be stored in a data store, such as a data store on the data server of the data storage service. In some of these embodiments, the customer may request that the enclave 1912 encrypt the data before storing the data. In some of these embodiments usable in combination with other embodiments, instructions executed within the enclave 1912 by a processor may encrypt the data by default before storing the data. In a variation of such an embodiment, the customer may ensure that the data is encrypted by the enclave 1912 by specifying, for example through an application programming interface call, that the data should pass through an enclave 1912 configured for encrypting the data in this manner before being stored to the data store. In another variation of said embodiments, instructions executed within the enclave 1912 by a processor may encrypt data by default unless the customer specifies that the data not be encrypted before storing in the data store.

In at least one embodiment, the customer has access to a private key for decrypting stored data in a data store of a data storage service, and in such cases the enclave 1912 passes the encrypted data to the customer. In other embodiments, the enclave 1912 has the private key and reads from the data store must pass through the enclave 1912 for decryption, and, in some embodiments, re-encryption. In some embodiments, both the customer and the enclave 1912 may have the private key and the customer may request the ciphertext from the data storage service (e.g., request to read the data directly) in order to verify that data is indeed being encrypted and that the key is valid (the same as the enclave 1912), by decrypting the ciphertext using the private key.

Note that one or more of the operations performed in processes described above may be performed in various orders and combinations, including parallel execution and execution in a non-deterministic order, for example. No ordering of operations of process flows illustrated in FIGS. 1-6 and FIGS. 8-18 are necessarily indicative of relative ordering of the operations unless otherwise stated. Pre-image resistant functions include one-way functions (i.e., functions that may not be computationally difficult to compute for a current value, but may not be computationally trivial to determine a previous value from the current value), having a recurrence relationship to a previous value of the function. The one-way membership function may not be mathematically proven/provable as one-way, but have computational complexity properties that render the function pre-image resistant. One-way functions (also referred to as “effectively one-way functions”) include, but are not limited to, cryptographic hash functions such as message authentication codes, (e.g., hash based message authentication code (HMAC)), key derivation functions, such as PBKDF2 and bcrypt (e.g., with the password being based at least in part on the plaintext and the cryptographic key) and other secure randomization functions which may, but do not necessarily, have a domain (set of possible inputs) that is larger than their range (possible outputs). Other suitable functions (referred to as “f”) for various embodiments include, but are not limited to, functions that take at least a plaintext and cryptographic key as input and that have a property of pre-image resistance (given a value y, the probability of randomly generating an input x such that f(x)=y is below a specified threshold), second pre-image resistance (given an input x₁, the probability of randomly generating another input x₂, different from x₁, such that f(x₁)=f(x₂) is below a specified threshold) and/or collision resistance (the probability of two different inputs resulting in the same output is less than a specified threshold). One-way functions suitable for use in generating an identifier for data include functions that satisfy properties of collision resistance (i.e., the probability of f(x₁)=f(x₂) for different x1 and x2 is below a threshold). Other hash functions usable in accordance with the techniques of the present disclosure include, but are not limited to, functions described in the National Institute of Standards and Technology (NIST) Special Publication 800-107, Revision 1 “Recommendation for Applications Using Approved Hash Algorithms,” which is incorporated herein by reference.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denote that the instructions are being executed by a machine, thereby causing the machine to perform the specified operations.

In at least some embodiment, a “blockchain” or “blockchain network” refers to any and all suitable forms of distributed ledgers, which includes consensus-based blockchain and transaction-chain technologies, permissioned and un-permissioned ledgers, shared ledgers, and more. Non-limiting examples of blockchain technology include Bitcoin and Ethereum, although other examples of blockchain technologies are also contemplated in the scope of this disclosure. While Bitcoin and Ethereum may be described in connection with various embodiments of this disclosure, those embodiments are to be construed merely as illustrative examples and not limiting. For example, alternative blockchain implementations and protocols are contemplated within the scope of the present disclosure.

A blockchain network may refer to a peer-to-peer electronic ledger implemented as a decentralized system. A ledger may comprise multiple blocks wherein a genesis block is a first block of the ledger and all other blocks reference a previous block. In at least some embodiment, each block (except the genesis block) includes a hash of the previous block to which that block became chained together to create an immutable record of the block to the blockchain ledger which cannot be modified, deleted, or otherwise altered. A block may include one or more blockchain transactions. A blockchain transaction may refer to a data structure that encodes the transfer of control of a digital asset between users of the blockchain network. For example, a blockchain transaction may transfer control of a digital asset from a source address to a destination address. The blockchain transaction may be signed with a private key associated with the address which can be cryptographically verified using a corresponding public key that is made available to other parties of the blockchain network. In at least one embodiment a blockchain transaction includes a transaction input and a transaction output.

In some embodiment, a blockchain transaction is validated before it is committed to the blockchain ledger as part of a block. Blockchain nodes may be used to verify blockchain transactions, which may include verifying digital signatures of transactions, verifying that a purported owner of a digital asset is actually the owner by inspecting the blockchain ledger to verify that control of the digital asset was transferred to the purported owner and that the purported owner has not elsewhere transferred control of the digital asset (meaning that the purported owner was previous the owner of the digital asset but has previously transferred control to another entity).

Validity in the blockchain context may be consensus based, and a transaction may be considered valid if a majority of nodes agrees that the blockchain transaction is valid. In at least some embodiments, a blockchain transaction references an unspent transaction output (UTXO) that is used to validate the transaction by executing the UTXO locking and unlocking script. If the UTXO locking and unlocking script executes successfully (e.g., by evaluating to TRUE and any other validation operations). Accordingly, a blockchain transaction is written to a blockchain ledger when it is validated by a node that receives the transaction and is added to a new block by a node (e.g., miner) and actually mined by being added to the public ledger of past transactions. In at least some embodiment, a blockchain transaction is considered to be confirmed when a certain number of subsequent blocks are added to the blockchain ledger, whereinafter the blockchain transaction becomes virtually irreversible.

A blockchain transaction output may include a locking script that “locks” a digital asset by specifying a condition that is to be met in order for the encumbrance to be lifted or unlocked (e.g., to allow control of the digital asset to be transferred to another user). A locking script may be referred to as an encumbrance. An unlocking script may be a corresponding script that in combination with the locking script, removes an encumbrance on digital assets. A locking script and unlocking script may be combined to form executable code that, if executed to completion or to yield a specific result, indicates that the unlocking script is valid and that the encumberance may be removed. For example, “scriptPubKey” is a locking script in Bitcoin and “scriptSig” is an unlocking script.

It should be noted that while blockchain technology is perhaps most widely known for its use cryptocurrency, there are many other applications for blockchain technologies for providing secure systems. A secure system may refer to a system in which functionality—such as the exchange of digital assets between two or more entities—is cryptographically verifiable. A secure system may be robust to failure. A secure system may be immutable such that information that is committed to the blockchain ledger cannot be unilaterally modified by an individual. A secure system may provide additional assurances, such as assurances of confidentiality, integrity, authenticity, and nonrepudiation. Confidentiality may refer to assurances that certain information is not made publicly available (e.g., the underlying identity of a blockchain address may be kept secret or unknown). Authenticity may refer to assurances that a message was created by a party purporting to be the author of the message. Integrity may refer to assurances that a received message was not modified either intentionally (e.g., by a malicious party) or unintentionally (e.g., as a result of signal loss during transmission) from its original form when the message was transmitted. Nonrepudiation may refer to assurances that a party that digitally signs a blockchain transaction cannot deny the authenticity of the transaction.

Mining may refer to the process of validating blockchain transactions along a blockchain network. Validating blockchain transactions may involve a process of securing and verifying blockchain transactions (e.g., organized as blocks) along a blockchain. Mining may be a process that helps maintain network security by ensuring that valid blocks are recorded on a blockchain ledger. Generally speaking, participants in a mining process can be rewarded for using computing resources (e.g., compute resources such as CPUs) to solve computational algorithms. Mining can be done in various ways. Proof-of-work (POW) and proof-of-stake (POS) consensus are two non-limiting examples of how mining can be done.

Proof-of-stake may refer to a consensus algorithm in which validators secure new blocks before they are added to a blockchain network. In a POS mining algorithm, a node may participate in the mining process by staking an amount of digital assets. The POS may be a deterministic concept that states individuals are allowed to mine or validate new blocks equal to proportionally to the amount staked—in other words, the more digital assets a node stakes, the greater mining power the node has. In some cases, greater mining power means that a node has more opportunity to validate blocks and be rewarded. Opportunity may refer to probabilistic opportunity, in which a probability p₁>p₂ does not necessarily guarantee that a first node with higher probability p₁ actually mines more than a second node with lower probability p₂ over a specific period of time. However, long-run, expected value of miners with larger staked amounts may be greater than those of miners with smaller staked amounts.

A node may become a miner by staking an amount of digital assets from the miner's blockchain wallet by transferring digital assets to a bound wallet. Miners, who may be called validators, delegates, or forgers, may be chosen or voted for randomly by holders of digital assets on the blockchain network. For a node to be chosen as a staker, the node needs to have deposited a certain amount or value of digital assets into a special staking wallet. In at least some embodiments, miners are entitled to forge or create new blocks proportional to the amount staked.

POS blockchain networks may have several important differences from POW blockchain networks. In general, anyone with enough digital assets can validate transactions on a blockchain network, and the benefits of specialized hardware such as application-specific integrated circuits (ASICs) is less pronounced than in POW blockchain networks. Generally speaking, POS blockchain networks may be more energy efficient and environmentally friendly than POW blockchain networks. Non-limiting examples of POS blockchain networks include: DASH; NEO; Lisk; Stratis; PIVX; OkCash; and more. Generally speaking, in a POW blockchain network, nodes with greater computing power are more likely to mine new blocks, whereas in POS blockchain networks, nodes with greater staking amounts are more likely to validators.

FIG. 20 is an illustrative, simplified block diagram of a computing device 2000 that can be used to practice at least one embodiment of the present disclosure. In various embodiments, the computing device 2000 may be used to implement any of the systems illustrated and described above. For example, the computing device 2000 may be configured for use as a data server, a web server, a portable computing device, a personal computer, or any electronic computing device. As shown in FIG. 20, the computing device 2000 may include one or more processors 2002 that, in embodiments, communicate with and are operatively coupled to a number of peripheral subsystems via a bus subsystem. In some embodiments, these peripheral subsystems include a storage subsystem 2006, comprising a memory subsystem 2008 and a file/disk storage subsystem 2010, one or more user interface input devices 2012, one or more user interface output devices 2014, and a network interface subsystem 2016. Such storage subsystem 2006 may be used for temporary or long-term storage of information.

In some embodiments, the bus subsystem 2004 may provide a mechanism for enabling the various components and subsystems of computing device 2000 to communicate with each other as intended. Although the bus subsystem 2004 is shown schematically as a single bus, alternative embodiments of the bus subsystem utilize multiple buses. The network interface subsystem 2016 may provide an interface to other computing devices and networks. The network interface subsystem 2016 may serve as an interface for receiving data from and transmitting data to other systems from the computing device 2000. In some embodiments, the bus subsystem 2004 is utilized for communicating data such as details, search terms, and so on.

In some embodiments, the user interface input devices 2012 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2000. In some embodiments, the one or more user interface output devices 2014 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2000. The one or more user interface output devices 2014 can be used, for example, to present user interfaces to facilitate user interaction with applications performing processes described and variations therein, when such interaction may be appropriate.

In some embodiments, the storage subsystem 2006 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 2006. These application modules or instructions can be executed by the one or more processors 2002. In various embodiments, the storage subsystem 2006 additionally provides a repository for storing data used in accordance with the present disclosure. In some embodiments, the storage subsystem 2006 comprises a memory subsystem 2008 and a file/disk storage subsystem 2010.

In embodiments, the memory subsystem 2008 includes a number of memories, such as a main random access memory (RAM) 2018 for storage of instructions and data during program execution and/or a read only memory (ROM) 2020, in which fixed instructions can be stored. In some embodiments, the file/disk storage subsystem 2010 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 2000 includes at least one local clock 2024. The at least one local clock 2024, in some embodiments, is a counter that represents the number of ticks that have transpired from a particular starting date and, in some embodiments, is located integrally within the computing device 2000. In various embodiments, the at least one local clock 2024 is used to synchronize data transfers in the processors for the computing device 2000 and the subsystems included therein at specific clock pulses and can be used to coordinate synchronous operations between the computing device 2000 and other systems in a data center. In another embodiment, the local clock is a programmable interval timer.

The computing device 2000 could be of any of a variety of types, including a portable computer device, tablet computer, a workstation, or any other device described below. Additionally, the computing device 2000 can include another device that, in some embodiments, can be connected to the computing device 2000 through one or more ports (e.g., USB, a headphone jack, Lightning connector, etc.). In embodiments, such a device includes a port that accepts a fiber-optic connector. Accordingly, in some embodiments, this device is that converts optical signals to electrical signals that are transmitted through the port connecting the device to the computing device 2000 for processing. Due to the ever-changing nature of computers and networks, the description of the computing device 2000 depicted in FIG. 20 is intended only as a specific example for purposes of illustrating the preferred embodiment of the device. Many other configurations having more or fewer components than the system depicted in FIG. 20 are possible.

FIG. 20 may one or more computer systems (e.g., one or more of computing device) 2000 that collectively implement a computing resource service provider. A computing resource service provider may provide a variety of services to its customers, and its customers may communicate with the computing resource service provider through an interface, which may be a web page or other type of customer interface. Each service of the services provided by the computing resource service provider may have its own interface and subsets of the services may have corresponding individual interfaces in addition to or as an alternative to a common interface. A customer may communicate with the computing resource service provider through a network, such as the Internet or intranet.

The computing resource service provider may also provide various computing resources and services to its customers, individually or in combination with other resources and services, and the computing resource service provider may further provide those services to the customer through a distributed computing environment. The services provided by the computing resource service provider may include services such as virtual computer system services, block-level data storage services, cryptography services, on-demand data storage services, notification services, authentication services, policy management services, task services and archival data storage services. Not all embodiments described include all the services described, and additional services may be provided in addition to or as an alternative to services explicitly described.

Services provided by a computing resource service provider may include interfaces that enable a customer to submit requests, for example, through appropriately configured API calls, to the various services. In addition, each of the services may include service interfaces that enable the services to communicate with or access each other (e.g., to enable a virtual computer system of the virtual computer system service to store data in or retrieve data from an on-demand data storage service and/or access block-level data storage devices provided by a block-level data storage service). Each of the service interfaces may also provide secured and/or protected access to each other through the use of encryption keys and/or other secured access methods, thereby enabling secure and/or protected access between them. Collections of services operating in concert on a distributed computer system may have a single front-end interface and/or multiple interfaces between the elements of the distributed computer system.

A computing resource service provider may provide a virtual computer system service that may be a collection of computer resources configured to instantiate virtual machine instances on behalf of the customer. Computing device 2000 may be used to instantiate the virtual machine instances. The customer may interact with the virtual computer system service to provision, place and operate virtual machine instances that are instantiated on computer systems operated by the computing resource service provider. The virtual machine instance may be used for various purposes, such as to operate as servers supporting a web site, to operate business applications, or, generally, to provide compute power to the customer. Other applications for the virtual machine instances may be to support database applications, electronic commerce (e-commerce) applications, business applications and/or other applications.

A virtual computer system service may be used by a computing resource service provider for providing computer system resources for customers. The virtual computer system service may provide such computer system resources by instantiating virtual machine instances on physical hardware. The physical hardware may include physical hosts, which may include any device or equipment configured to execute instructions for performing data computation, manipulation or storage tasks, such as a computer or server. A physical host may be equipped with any needed processing capability including processors 2002, such as a CPU, GPU, DSP, memory, storage devices, buses, input/output ports, and networking equipment. The physical hardware may also support specialized instructions such as, for example, SGX instructions, TPM instructions or the like. In various embodiment described throughout this disclosure, encryption techniques may, based on context, include authenticated encryption techniques.

A computer system of a computing resource service provider may be configured to support a virtualization layer to provide computational resources upon which virtual machines may operate. The virtualization layer may manage memory 1906 and processor scheduling for all virtual machines operating on the computer system. The virtualization layer may also launch and/or manage a control domain, also known as a privileged domain, which is a virtual machine having direct access to the hardware of the computer system. The virtualization layer may be any device, software or firmware, used for providing a virtual computing platform for the virtual machines. The virtual machines of the virtualization layer may be provided to customers of the computing resource service provider, and the customers may run an operating system and/or applications on the virtual machines of the customer. An example of a virtualization layer includes a hypervisor.

In some embodiments, an input/output module includes any type of communication channel by which two or more devices (e.g., a device such as computing device 2000) may communicate, including physical network cables, wireless communications, universal serial bus (USB), serial, parallel, and other conduits. The network may be any suitable network, including the Internet, an intranet, wide area network (WAN), local area network (LAN), and direct connection. The network may further be configured to facilitate communications of any type of communication protocol, including a cellular wireless communications protocol, such as fourth generation (4G) communications or long term evolution (LTE™), a wireless local area network (WLAN) communications protocol, such as an Institute for Electrical and Electronics Engineers (IEEE) 802.11, 802.16 or 802.21 communication protocol, or short range communications protocol, among others.

Note that, unless otherwise specified, expressions regarding executable instructions (also referred to as code, applications, agents, etc.) performing operations that instructions do not ordinarily perform unaided (e.g., transmission of data, calculations, and the like) denote that the instructions are being executed by a machine, thereby causing the machine to perform the specified operations.

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. Further, unless stated otherwise or otherwise clear from context, the phrase “based on” means “based at least in part on” and not “based solely on.” Further, unless stated otherwise or otherwise clear from context, “some embodiments” may refer to “one or more embodiments.”

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining, within a protected execution environment, at least a plurality of approver digital signatures, a message, and a raw blockchain transaction;
verifying validity of at least a subset of the plurality of approver digital signatures;
verifying that the message and the raw blockchain transaction match;
on a condition that at least the subset of approver digital signatures are valid and that the message matches the raw blockchain transaction, using a private key to generate a digital signature over the raw blockchain transaction; and
making at least the digital signature generated over the raw blockchain transaction available outside of the protected execution environment.

2. The method of claim 1, wherein the subset forms a quorum of validated approver digital signatures.

3. The method of claim 1, further comprising:
obtaining at a non-protected region of a hot wallet, a request from a first approver comprising a first approver digital signature of the plurality of approver digital signatures and the message;
providing the message to one or more other approvers; and
receiving, in response to the provided message, other approver digital signatures of the plurality of approver digital signatures.

4. The method of claim 1, further comprising broadcasting the raw blockchain transaction and the digital signature generated over the raw blockchain transaction to a blockchain network.

5. The method of claim 1, wherein the message encodes a blockchain identifier, token address, wallet address, one or more recipient addresses, and one or more digital assets.

6. The method of claim 5, wherein the one or more digital assets encodes either a token identifier associated with a non-fungible token or an amount of fungible tokens.

7. The method of claim 1, wherein the protected execution environment supports Intel® Software Guard eXtensions (SGX).

8. The method of claim 1, wherein the private key is inaccessible to the outside of the protected execution environment.

9. A system, comprising:
one or more processors; and
memory storing a set of instructions that, as a result of execution by the one or more processors, cause the system to:
obtain, within a protected execution environment, at least a plurality of approver digital signatures, a message, and a raw blockchain transaction;
verify validity of at least a subset of the plurality of approver digital signatures;
verify that the message and the raw blockchain transaction match;
on a condition that at least the subset of approver digital signatures are valid and that the message matches the raw blockchain transaction, use a private key to generate a digital signature over the raw blockchain transaction; and
make at least the digital signature generated over the raw blockchain transaction available outside of the protected execution environment.

10. The system of claim 9, wherein the instructions include further instructions that, as a result of execution by the one or more processors, cause the system to:
obtain at a non-protected region of a hot wallet, a request from a first approver comprising a first approver digital signature of the plurality of approver digital signatures and the message;
provide the message to one or more other approvers; and
receive, in response to the provided message, other approver digital signatures of the plurality of approver digital signatures.

11. The system of claim 9, wherein the instructions include further instructions that, as a result of execution by the one or more processors, cause the system to broadcast the raw blockchain transaction and the digital signature generated over the raw blockchain transaction to a blockchain network.

12. The system of claim 9, wherein the subset is at least a threshold number or percentage of the plurality of approver digital signatures.

13. The system of claim 9, wherein the protected execution environment supports a hardware security module (HSM).

14. A non-transitory computer-readable storage medium storing executable instructions that, as a result of execution by one or more processors of a computer system, cause the computer system to:
obtain, within a protected execution environment, at least a plurality of approver digital signatures, a message, and a raw blockchain transaction;
verify validity of at least a subset of the plurality of approver digital signatures;
verify that the message and the raw blockchain transaction match;
on a condition that at least the subset of approver digital signatures are valid and that the message matches the raw blockchain transaction, use a private key to generate a digital signature over the raw blockchain transaction; and
make at least the digital signature generated over the raw blockchain transaction available outside of the protected execution environment.

15. The non-transitory computer-readable storage medium of claim 14, wherein the subset is all of the plurality of approver digital signatures.

16. The non-transitory computer-readable storage medium of claim 14, wherein the instructions comprise further instructions that, as a result of execution, causes the computer system to further:
obtain at a non-protected region of a hot wallet, a request from a first approver comprising a first approver digital signature of the plurality of approver digital signatures and the message;
provide the message to one or more other approvers; and
receive, in response to the provided message, other approver digital signatures of the plurality of approver digital signatures.

17. The non-transitory computer-readable storage medium of claim 14, wherein the instructions include further instructions that, as a result of execution by the one or more processors, cause the system to broadcast the raw blockchain transaction and the digital signature generated over the raw blockchain transaction to a blockchain network.

18. The non-transitory computer-readable storage medium of claim 17, wherein the blockchain network is an Ethereum-based blockchain network.

19. The non-transitory computer-readable storage medium of claim 14 wherein the private key is persisted in a security module.

20. The non-transitory computer-readable storage medium of claim 14, wherein the raw blockchain transaction encodes a transfer of digital assets from a first blockchain user associated with the private key to a second blockchain user.
